(19) United States
(12) Patent Application Publication
(10) Pub. No.: US 2015/0154663 A1
(43) Pub. Date: Jun. 4, 2015

(54) PROPERTY APPRAISAL DISCREPANCY DETECTION AND ASSESSMENT

(71) Applicant: FANNIE MAE, Washington, DC (US)

(72) Inventors: Kent R. Willard, Takoma Park, MD (US); Franklin Carroll, Catonsville, MD (US); Kevin Chung, Washington, DC (US); Zachary Dawson, Washington, DC (US); Eric Rosenblatt, Derwood, MD (US); Sampat Saraf, Great Falls, VA (US)

(73) Assignee: FANNIE MAE, Washington, DC (US)

(21) Appl. No.: 14/095,112

(22) Filed: Dec. 3, 2013

(51) Int. Cl. G06Q 30/02; G06Q 50/16

(52) U.S. Cl. CPC G06Q 30/0278; G06Q 50/16

(57) ABSTRACT

An appraisal error detection method includes accessing a database of appraisal-data-field entries of property appraisals. Because sales transactions are cited repetitively as comparables on multiple appraisals, it is possible to inspect appraisal-data-field entries for consistency. An error detection operation is performed for each of the corresponding appraisal-data-field entries by detecting any discrepancies, both between appraisers, and between different appraisals by the same appraisers, where corresponding appraisal-data-field entries are for a same property characteristic of a same property. Appraisal-data-field entries determined by the error detection operation to be erroneous are flagged, and a discrepancy score may be assigned to flagged erroneous entries that indicates an amount of risk posed by the entry. Appraisals in the database may be assigned a score based upon the sum of their entries' discrepancy scores.

### BACKGROUND

1. Field of the Invention

The present invention relates generally to computer analysis of real estate appraisal data, with special attention paid to identifying and evaluating data errors.

2. Description of the Related Art

A property appraisal is an opinion of the value of a given property based on certain facts. Property appraisals are commonly made by a residential appraiser based on facts ascertained by the appraiser. Generally, the appraiser estimates the value of the property that is the subject of appraisal (hereinafter the “subject property”) by considering the sale price of properties that are similar to the subject property and that have recently been sold (hereinafter “comparable(s)” or “comp(s)”). Most appraisals include forms (whether printed or electronic) that include data fields in which the appraiser represents the various facts about the subject property and the comps upon which the appraisal is based.

Some appraisers may enter false values into the data fields of the appraisal form. This entry of false data may be an intentional misrepresentation by the appraiser in order to change an appraised value of the subject property. For example, there may be an incentive for some appraisers to over-estimate the value of a subject property, perhaps in order to please a real estate agent who refers business to the appraiser. For example, if a comp used in an appraisal sold for $300,000, all other things being equal the subject property is likely also worth around $300,000 (actual details of such an evaluation are discussed further below); however if an appraiser wanted to increase the appraised value of the subject property, the appraiser could misrepresent the sales price of the comp as $320,000, which would correlatively increase the apparent value of the subject property. Such intentional misrepresentations are referred to hereinafter as fraud or fraudulent errors.

The false value entered into the data field may alternatively represent an error made by the appraiser, rather than fraud. For example, when the appraiser is ascertaining the various facts about the subject property or comps, the appraiser may make an error in measurement or identification. For example, the appraiser may accidentally measure the Lot Size of the subject property to be 10,000 sq. ft. when it is in fact 10,500 sq. ft., or the appraiser may accidentally misidentify as a bedroom a room that does not qualify as a bedroom. Such accidental misrepresentations are referred to hereinafter as accidental or negligent errors.

False data field entries, whether accidental or fraudulent, result in the estimated value of the subject property being inaccurate—i.e., the property is either over- or under-valued. Such inaccurate valuation of the subject property can be a source of collateral risk for those that rely upon the appraised value of a property, such as institutions involved in providing a mortgage for the subject property or creating/trading instruments backed by the subject property.

An appraisal reviewer attempts to determine the acceptability of an appraised value, generally by manually verifying that the comparable selections, adjustments, and reconciliations made by the appraiser meet standards and are mathematically correct. However, an appraisal reviewer generally cannot determine whether the appraiser's representations about the characteristics of the subject property and the characteristics of the comps are accurate without making a physical visit to each property used in an appraisal, which is clearly not feasible. At best, appraisal reviewers generally can only detect palpable errors such as data field entries 130 without any value entered at all.

### SUMMARY

According to an aspect of one exemplary illustration of the present disclosure, a method may include causing a processor to: access appraisal-data-field entries from a plurality of property appraisals, each of the appraisal-data-field entries indicating a value assigned to a property characteristic of a property included in the respective property appraisal; perform an error detection operation for each of the accessed appraisal-data-field entries as a target entry, the error detection operation comprising detecting a discrepancy between the target entry and an appraisal-data-field entry corresponding to the target entry; and flag as erroneous each appraisal-data-field entry determined by the error detection operation to be erroneous. Appraisal-data-field entries correspond to one another when they indicate respective values assigned to a same property characteristic of a same property.

According to another aspect of the above-mentioned exemplary illustration, the method may further include causing the processor to assign respective numerical discrepancy values to flagged appraisal-data-field entries. A magnitude of the discrepancy value assigned to at least one of the flagged appraisal-data-field entries may be different than a magnitude of the discrepancy value assigned to at least one other of the flagged appraisal-data-field entries.

According to another aspect of the above-mentioned exemplary illustration, the method may further include causing the processor to assign a total discrepancy score to at least one of the plurality of property appraisals that depends upon a sum of any numerical discrepancy values assigned to those appraisal-data-field entries that are included in the property appraisal being assigned the total discrepancy score.

According to another aspect of the above-mentioned exemplary illustration, the method may further include causing the processor to display data corresponding to at least some of the plurality of property appraisals, the displayed data including the respective total discrepancy scores assigned thereto, receive input specifying one of the displayed property appraisals, and display in response to the received input at least any flagged appraisal-data-field entries of the specified property appraisal in association with respective deemed-correct values for the displayed flagged appraisal-data-field entries.

According to another aspect of the above-mentioned exemplary illustration, respective magnitudes of the assigned discrepancy values may depend at least in part upon how much the flagged appraisal-data-field being assigned the discrepancy value affects valuation of a subject property in the property appraisal that includes the flagged appraisal-data-field entry being assigned the discrepancy value.

According to another aspect of the above-mentioned exemplary illustration, respective magnitudes of the assigned discrepancy values may depend on a type of property characteristic indicated by the flagged appraisal-data-field entry being assigned a discrepancy value, and said types of property characteristics 140 may include sales price, gross living area, and lot size.

According to another aspect of the above-mentioned exemplary illustration, respective magnitudes of the assigned discrepancy values may depend on at least one of: a type of property characteristic indicated by the flagged appraisal-data-field entry being assigned the discrepancy value, a discrepancy type of the discrepancy detected for the flagged appraisal-data-field entry being assigned the discrepancy value, and a magnitude of the discrepancy detected for the flagged appraisal-data-field entry being assigned the discrepancy value.

According to another aspect of the above-mentioned exemplary illustration, the magnitude of the numerical discrepancy value may further depend upon whether the target entry corresponds to a subject property of the respective property appraisal that includes the target entry.

According to another aspect of the above-mentioned exemplary illustration, respective magnitudes of the assigned discrepancy values may depend on a discrepancy type of the discrepancy detected for the flagged appraisal-data-field entry being assigned the discrepancy value, and said discrepancy types may include self-discrepancies and peer-discrepancies.

According to another aspect of the above-mentioned exemplary illustration, a target entry for which a self-discrepancy is detected may be flagged as erroneous when at least one of the following is true: a value different from the value of the target entry is agreed upon by at least a predetermined number of appraisal-data-field entries that correspond to the target entry, and the target entry inflates a valuation of a subject property of the appraisal that includes the target entry.

According to another aspect of the above-mentioned exemplary illustration, a target entry for which a peer-discrepancy is detected may be flagged as erroneous when a value different from the value of the target entry is agreed upon by at least a predetermined number of appraisal-data-field entries that correspond to the target entry.

According to another aspect of the above-mentioned exemplary illustration, the discrepancy types may include outlier discrepancies, and a flagged appraisal-data-field entry may have an outlier discrepancy when: a magnitude of the discrepancy detected for the target entry exceeds a predetermined threshold, and the target entry inflates a valuation of a subject property of the appraisal that includes the target entry.

According to another aspect of the above-mentioned exemplary illustration, for at least one type of property characteristic, a higher discrepancy value may be assigned when a detected discrepancy is both a self-discrepancy and a peer-discrepancy than when an otherwise identical detected discrepancy is only one of a peer-discrepancy and a self-discrepancy.

According to another aspect of the above-mentioned exemplary illustration, for at least one type of property characteristic, a higher discrepancy value may assigned when a self-discrepancy is detected than when an otherwise identical peer-discrepancy is detected.

According to an aspect of another exemplary illustration of the present disclosure, a method may include causing a processor to: access appraisal-data-field entries from a plurality of property appraisals, each of the appraisal-data-field entries indicating a value assigned to a property characteristic in the respective property appraisal; associate with one another those appraisal-data-field entries that correspond to a same property as one another, correspond to a same property characteristic as one another, and have transaction dates separated by less than a predetermined time from of one another; perform an error detection operation for each of the accessed appraisal-data-field entries as a target entry, the error detection operation comprising detecting a discrepancy between the target entry and an appraisal-data-field entry associated therewith; flag as erroneous each appraisal-data-field entry determined by the error detection operation to be erroneous, said flag indicating a type and magnitude of the detected discrepancy; and identify at least one property appraisal of the plurality of property appraisals as suspect based upon flagged appraisal-data-field entries.

According to an aspect of another exemplary illustration of the present disclosure, a computer program product may comprise a non-transitory computer readable medium having program code stored thereon, the program code being executable by a processor to perform the method of any of the above-mentioned exemplary illustrations.

According to an aspect of another exemplary illustration of the present disclosure, a computing device may include at least one processor, and a memory unit, having stored thereon program code executable by the at least one processor to perform the method of any of the above-mentioned exemplary illustrations.

According to an aspect of another exemplary illustration of the present disclosure, a system may include at least one processor; a database including a plurality of appraisal-data-field entries from a plurality of property appraisals, each of the appraisal-data-field entries indicating a value assigned to a property characteristic in the respective property appraisal; and a non-transitory computer readable medium having program code stored thereon, the program code being executable by the at least one processor to perform the following operations: access the appraisal-data-field entries from the database, perform an error detection operation for each of the accessed appraisal-data-field entries as a target entry, the error detection operation comprising detecting a discrepancy between the target entry and an appraisal-data-field entry corresponding to the target entry, flag as erroneous each appraisal-data-field entry determined by the error detection operation to be erroneous, said flag indicating a type and magnitude of the discrepancy, and identify at least one property appraisal of the plurality of property appraisals as suspect based upon flagged appraisal-data-field entries. Appraisal-data-field entries may correspond to one another when they indicate respective values assigned to a same property characteristic of a same property.

The present invention can be embodied in various forms, including business processes, computer implemented methods, computer program products, computer systems and networks, user interfaces, application programming interfaces, and the like. The foregoing summary is intended merely to give a general idea of various aspects of exemplary illustrations of the invention, and does not limit the invention in any way.

### BRIEF DESCRIPTION OF THE DRAWINGS

These and other more detailed and specific features of the present invention are more fully disclosed in the following specification, reference being had to the accompanying drawings, in which:

FIG. 1 is a conceptual diagram illustrating an exemplary property appraisal form.

FIG. 2 is a conceptual diagram illustrating exemplary property appraisal data.

FIG. 3 is a conceptual diagram illustrating exemplary property appraisal data.

FIG. 4 is a conceptual diagram illustrating exemplary property appraisal data.

FIG. 5 is a conceptual diagram illustrating exemplary property appraisal data.

FIG. 6 is a conceptual diagram illustrating exemplary property appraisal data.

FIG. 7 is a conceptual diagram illustrating exemplary property appraisal data.

FIG. 8 is a conceptual diagram illustrating exemplary property appraisal data.

FIG. 9 is a conceptual diagram illustrating exemplary property appraisal data.

FIG. 10 is a conceptual diagram illustrating exemplary property appraisal data.

FIG. 11 is a conceptual diagram illustrating exemplary property appraisal data.

FIG. 12 is a conceptual diagram illustrating exemplary property appraisal data.

FIG. 13 is a block diagram illustrating an exemplary computing device.

FIG. 14 is a schematic diagram illustrating an exemplary system.

FIG. 15 is a schematic diagram illustrating an exemplary system.

FIG. 16 is a flowchart illustrating an exemplary process of assigning total discrepancy scores to property appraisals.

FIG. 17A is a flowchart illustrating an example of the subprocess “A” included in the process that is illustrated in FIG. 16.

FIG. 17B is a flowchart illustrating an example of the subprocess “B” included in the process that is illustrated in FIG. 16.

FIG. 18 is a table illustrating an exemplary allocation of discrepancy points according to type of discrepancy and property characteristic.

FIG. 19 is a table illustrating an exemplary way to determine whether a value inflates valuation of a subject property in an appraisal.

FIG. 20 is a table illustrating an exemplary tie-breaking procedure for determining whether a value is a deemed-correct value.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

Appraisal Data Field Entries:

As noted above, an appraiser estimates the value of the subject property by considering the sale price of comps. However, because no comp is exactly the same as the subject property, appraisers generally “adjust” the sale price of the comps to reflect the differences between the comp and the subject property. The appraiser attempts to determine how certain property characteristics (such as gross living area (“GLA”), number of bathrooms, etc.) affect the sale price of a property, and establishes adjustment factors for adjusting the sales prices of comps based on this determination. For example, suppose that an appraiser believes that in a particular market each bathroom contributes $10,000 to the price of a property. In such an example, if a given comp is practically identical to the subject property except that the comp has 3 bathrooms while the subject property has 2 bathrooms, then the appraiser would “adjust” the comp price down $10,000 to reflect this difference. Thus, if the exemplary comp sold for $200,000, then the appraiser might estimate the value of the subject property to be $190,000 ($200,000 comp sales price minus $10,000 for having one less bathroom). In practice more than one comp is used in each appraisal in order to increase accuracy (generally at least three), in which case each comp is “adjusted” and an estimated value of the subject property is determined based on the adjusted comps' prices (for example, averaging the adjusted comps' prices).

Various price-affecting characteristics of properties can be used in appraisals, and there are various means for estimating how much such characteristics affect value. For example, appraisers might rely upon their own subjective experience to estimate how much each property characteristic contributes to total value. Alternatively, mathematical techniques may be used to estimate adjustment factors. For example, automated valuation models (AVMs) may derive adjustment factors from a pool of property data by performing a regression on a hedonic equation. Once such adjustment factors are derived, an appraiser may be able to simply enter characteristics of the subject property and characteristics of selected comparable properties into data fields of the AVM, and the AVM can automatically make the appropriate adjustments to the comps and estimate a value of the subject property.

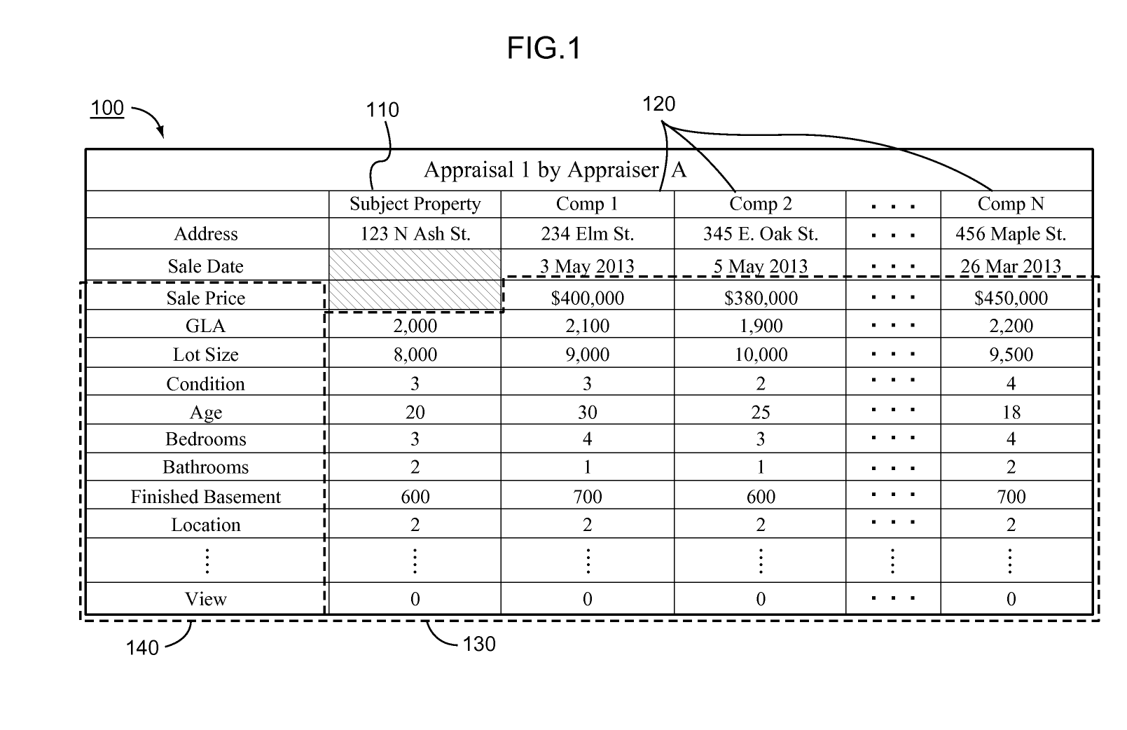

Most appraisal systems (including AVM systems and others) include numerous data fields for each appraisal (sometimes hundreds of such fields), with each data field corresponding to a characteristic of the subject property or comps. The appraiser assesses each property characteristic and enters a value into the corresponding data field. FIG. 1 is an illustration of an exemplary appraisal form 100 of an exemplary AVM system, including data field entries 130 corresponding to property characteristics 140. The data field entries 130 for each property characteristic 140 of the subject property 110 and of the comps 120 are filled in by the appraiser.

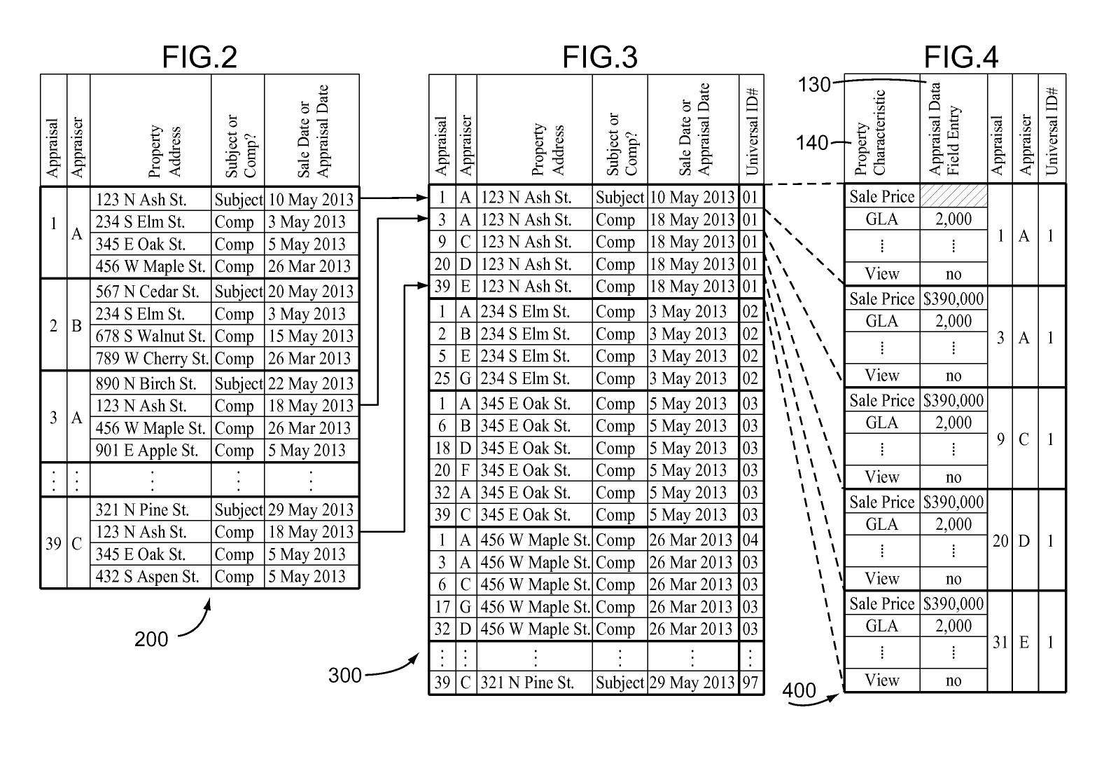

FIG. 2 illustrates exemplary property appraisal data 200 (stored, for example, in a database). As shown in FIG. 2, each instance of appraisal data corresponds to an appraisal that was performed by a particular appraiser and includes various instances of property data—one instance of property data for each property (e.g., subject or comp) that was used in the appraisal. FIG. 3 illustrates exemplary property data 300. The property data 300 of FIG. 3 correspond to the property data included in the appraisal data 200 of FIG. 2, except that the property data 300 of FIG. 3 are assigned universal ID (“UID”) numbers (discussed further below) and are grouped by UID. As FIG. 4 illustrates, each instance of property data includes various data field entries 130 corresponding to entries made by the appraiser who made the appraisal that corresponds to the instance of appraisal data that contains the respective instance of property data.

A given property is often used in multiple appraisals. Moreover, a single appraiser may use the same property in multiple appraisals. For example, as shown in FIGS. 2 and 3, the property located at 123 N Ash St. is the subject property of appraisal #1 performed by appraiser A, and is also subsequently used as a comp in appraisals #3, #9, #20, and #39 performed by appraisers A, C, D, and C respectively. In each of these appraisals, the same property characteristics 140 of the property are attested to. Because the given property presumably has not changed in the short time between appraisals, the entered property characteristics 140 ideally should be identical for characteristics that are objectively measurable (such as GLA), and at least very similar for characteristics that are more subjective (such as condition). Accordingly, if a data field entry 130 for a given property characteristic 140 of a given property is different in two appraisals, then one of the discrepant values is likely an error (whether accidental or intentional).

Regardless of the appraisal system that is used, the result of the appraisal will depend upon the appraiser's representations about the characteristics of the subject property and the characteristics of the comps. If an appraiser erroneously or fraudulently misrepresents a characteristic of the subject property or a characteristic of a comp (i.e., enters an inaccurate value in a data entry field), then the estimated value of the subject property resulting from the appraisal will be, at best, inaccurate and at worst, a source of collateral risk.

### First Illustrative Example

### Appraisal Evaluation Module

In one illustrative example of the present disclosure, an appraisal evaluation module analyzes a pool of property appraisals and automatically determines a score for each appraisal (a “total discrepancy score”). The total discrepancy score indicates an amount of risk that the appraisal over or under valued the subject property, and gives an indication of overall quality of the appraisal. The total discrepancy score allows appraisal reviewers to easily identify those appraisals that need the most scrutiny, and to focus manual review on these appraisals. The total discrepancy score also facilitates analysis of the reliability of appraisers and detection of potentially fraudulent behavior.

In the illustrative example, the appraisal evaluation module searches the data field entries of property appraisals that are stored in a database (“appraisal data field entries”) and determines whether there are any erroneous values. The appraisal evaluation module identifies erroneous values by detecting discrepancies between corresponding data field entries and determining for each discrepancy if one of the discrepant values is erroneous. A discrepancy score may be assigned to each erroneous data field that is identified, the magnitude of the score reflecting the likely amount of risk the particular error creates. The total discrepancy score may represent a scaled score based on the sum of discrepancy scores assigned to erroneous data fields used in the appraisal.

The magnitude of the discrepancy score assigned to an erroneous data field entry 130 may represent the likely amount of risk created by the error. For example, the discrepancy score may depend on characteristics of the error that are correlated with risk, including: the type of the discrepancy, the nature of the property characteristic 140 represented by the erroneous data field, the magnitude of the error, and whether the error tends to inflate or deflate the estimated value of the subject property, to name a few examples. Some specific examples of how the discrepancy score may be assigned are discussed in greater detail below.

Exemplary Processes of the Appraisal Evaluation Module:

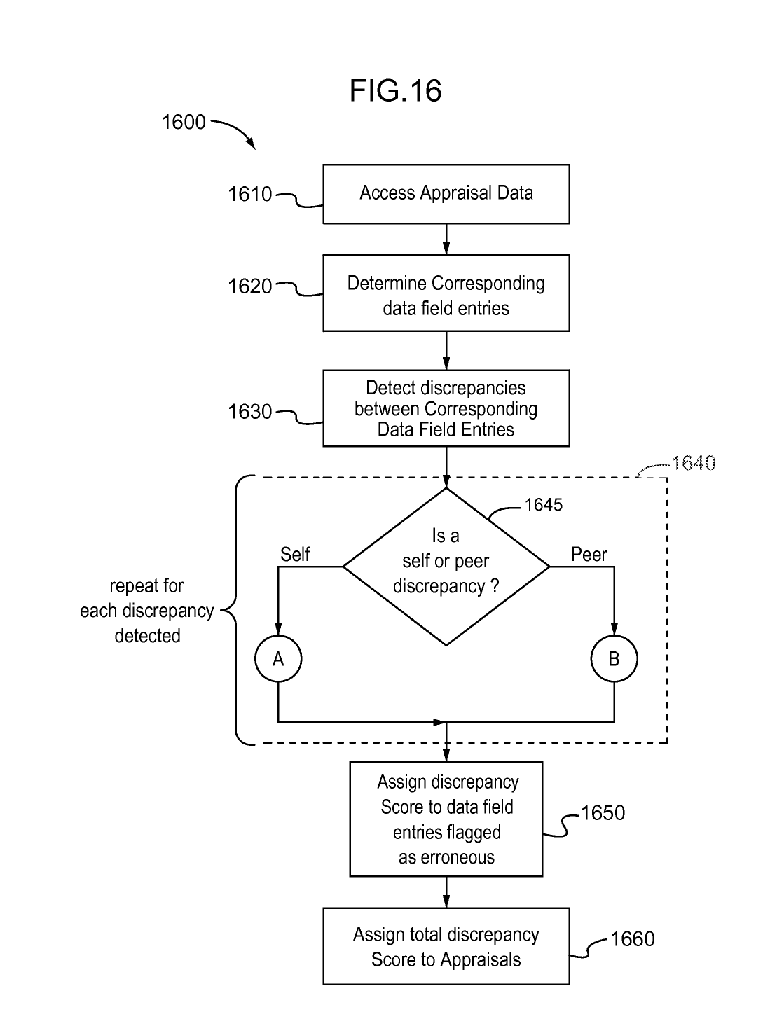

FIG. 16 illustrates an exemplary flowchart for processes performed by the exemplary error detection module. In process step 1610, data field entries of appraisal data are accessed from a database.

In process step 1620, corresponding data field entries are determined. For example, the appraisal evaluation module may identify corresponding data field entries by assigning a universal identification number (hereinafter “UID”) to each instance of property data that has a same property address, and then treat those data field entries that have a same UID and that correspond to a same property characteristic as corresponding data field entries. For example, FIG. 3 illustrates property data 300 in which a UID of 01 is assigned to each instance of property data having a property address of 123 N Ash St. FIG. 4 illustrates an example of the property characteristics 140 and associated data field entries 130 of each instance of property data having the UID 01. In FIG. 4, for example, each of the data field entries 130 for GLA are identified by the appraisal evaluation module as corresponding data field entries, since they correspond to a same property characteristic 140 (i.e., GLA) and have a same UID (i.e., 01).

The appraisal evaluation module may also be configured to assign a same UID to only instances of property data having transaction dates that are relatively close in time (i.e., sale/appraisal dates that are separated by less than a predetermined amount of time). This is because the characteristics of the property may change over time and thus data field entries from different appraisals occurring far apart in time may be legitimately discrepant without necessarily indicating error. If a property characteristic 140 changes between two appraisals, there would be a discrepancy in data field entries 130 of the two appraisals, but both data field entries 130 would be correct. Accordingly, the predetermined amount of time may be set low enough to minimize the likelihood that property characteristics 140 will change between appraisals, while still being high enough that each set of corresponding data field entries still includes enough entries for a meaningful comparison. The predetermined amount of time may be advantageously set, merely as an example, to around three months.

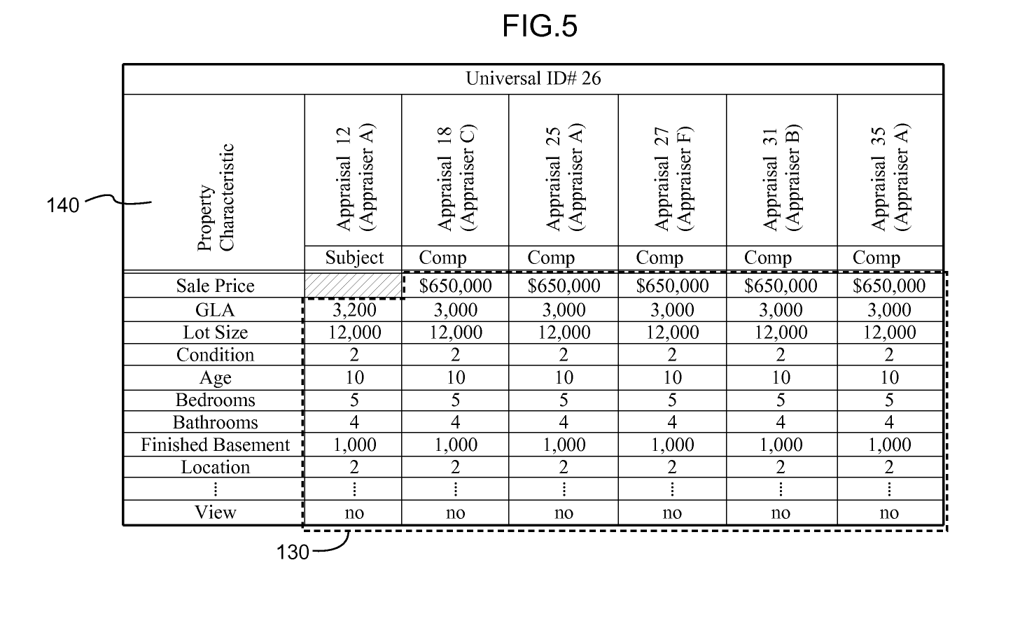

In process step 1630, the appraisal evaluation module may detect discrepancies between corresponding data field entries. A discrepancy is a not-insignificant difference between two or more corresponding data field entries. FIG. 5 illustrates an exemplary collection of corresponding data field entries for the UID 26. In FIG. 5, each row in the table signifies a different set of corresponding data field entries, one set of corresponding data field entries for each property characteristic 140. For simplicity, a set of corresponding data field entries may be identified herein by the name of the property characteristic 140 associated therewith in brackets with the UID in subscript, such as “[Sale Price]₀₁”. Thus, in FIG. 5, the set of corresponding data field entries designated by [GLA]₂₆ corresponds to all of the data field entries 130 that are for the property characteristic “GLA” and that are for properties having the UID of 26. The set [GLA]₂₆ has a discrepancy—the GLA data field entry 130 for Appraisal #12 (3,200 sq. ft.) is different from all of the other corresponding data field entries (3,000 sq. ft.). The appraisal evaluation module will detect all such discrepancies in all sets of corresponding data field entries.

The appraisal evaluation module may be configured to detect as discrepancies only those differences between data field entries that are larger than a predetermined significance threshold (i.e., insignificant differences are ignored). A different significance threshold value may be set for each type of property characteristic 140. The significance threshold may be based on considerations such as how much the property characteristic 140 tends to effect the valuation of the subject property in the appraisal containing the error and/or on acceptable margins of human error. Errors in some property characteristics 140 (such as GLA) affect valuation more than others, and these types of errors therefor may desirably have a comparatively lower significance threshold. Moreover, a certain margin of error in measuring some property characteristics 140 (such as Lot Size) is expected, while other property characteristics 140 (such as Bedrooms) may have very low or even no acceptable margin of error.

In process step 1640, the appraisal evaluation module may determine for a given discrepancy detected in process step 1630 which of the discrepant values (if any) is the erroneous value. The mere fact that two values are different does not immediately indicate which of the two different values is the correct one. However, the appraisal evaluation module may apply various selection rules to determine which of the discrepant values is most likely the correct value. The appraisal evaluation module may determine a deemed-correct value for each discrepancy, and flag as an error the data field entry 130 that is discrepant from the deemed-correct value. For example, the appraisal evaluation module may set a consensus value of the set of corresponding data field entries as the deemed-correct value for the discrepancy. The consensus value may be a value agreed upon by a certain proportion (e.g., a majority) of the corresponding data field entries.

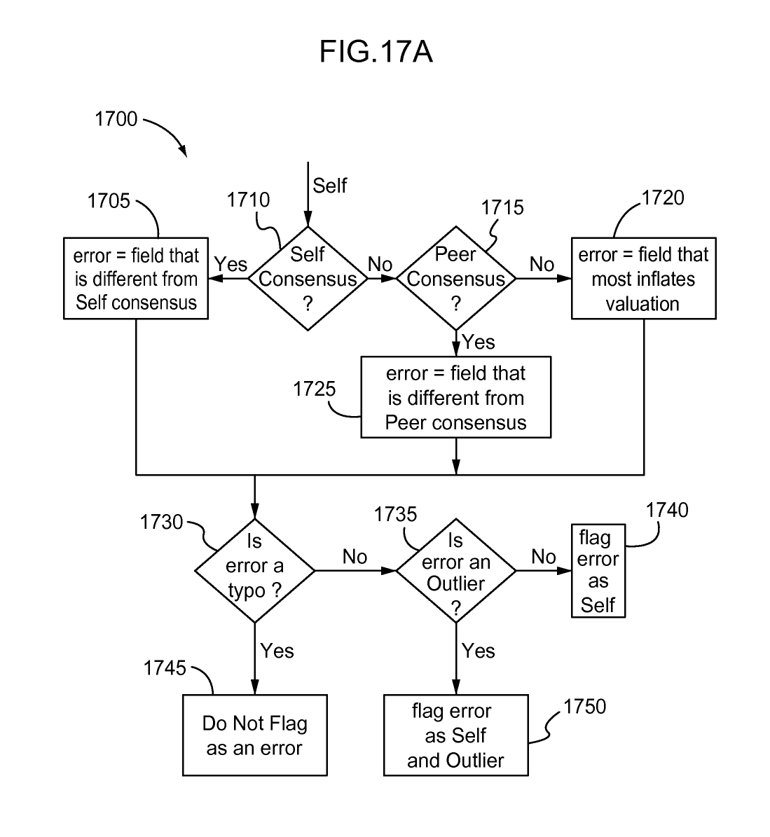

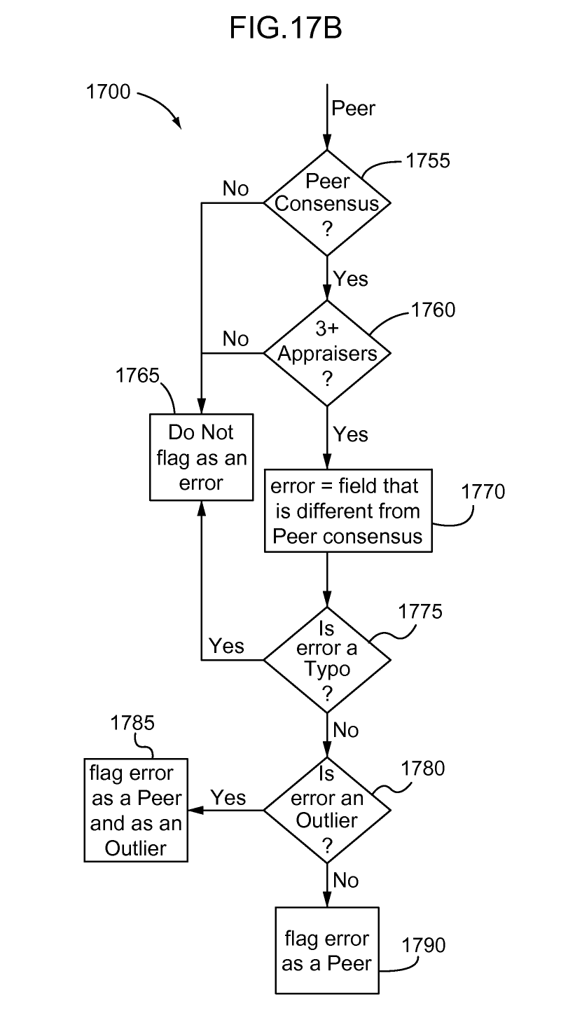

Preferably, the appraisal evaluation module may determine a deemed-correct value to be used for a particular discrepancy based upon a type of the discrepancy, and may apply different criteria for determining a deemed-correct value for different types of discrepancies (discussed in greater detail below). Types of discrepancies may include, for example, self-discrepancies, peer-discrepancies, outlier-discrepancies, and typographical errors. Accordingly, process step 1640 may preferably include therein decision block 1645 in which it is determined whether the discrepancy is of a self-discrepancy type or a peer-discrepancy type. A self-discrepancy is a discrepancy between corresponding data field entries entered by the same appraiser. A peer-discrepancy is a discrepancy between corresponding data field entries entered by different appraisers. If the discrepancy is a self-discrepancy type, then the process continues to sub-process A, illustrated in FIG. 17A. If the discrepancy is a peer-discrepancy type, then the process continues to sub-process B, illustrated in FIG. 17B. It is possible for a discrepancy to be both a self-discrepancy and a peer-discrepancy, in which case both sub-processes A and B are performed for that discrepancy. The process step 1640 is repeated for each discrepancy detected in process step 1630, and each data field entry 130 determined by the process step 1640 to be an error is flagged as erroneous.

In process step 1650, a discrepancy score is assigned to data field entries flagged in process step 1640 as erroneous. Details regarding the discrepancy score are discussed further below.

In process step 1660, a total discrepancy score is assigned to each appraisal based on the discrepancy scores assigned to data field entries included in the respective appraisal. Details regarding the total discrepancy score are discussed further below.

Self-Discrepancies:

As discussed above, whether or not a discrepancy is determined to be an error, and if determined to be an error what discrepancy score should be assigned thereto, may depend upon a type of the discrepancy. For example, as discussed above, in the preferred configuration of the process step 1640 illustrated in FIG. 16, if the discrepancy is a self-discrepancy type, then the process continues to sub-process A as illustrated in FIG. 17A to determine which if any of the discrepant values is an error. As noted above, a self-discrepancy is a discrepancy between corresponding data field entries entered by the same appraiser.

In decision block 1710, it is determined whether or not there is a self-consensus. A self-consensus exists if there is a value in the set of corresponding data field entries that was used by the appraiser in question more often than any other value.

If there is a self-consensus (i.e., decision block 1710 result=YES), then the deemed-correct value for the discrepancy in question may be the value used most often by that appraiser. Thus, in process step 1705, the data field entry 130 entered by the appraiser in question that differs from this deemed-correct value is determined to be the erroneous value. For example, there is a self-discrepancy in the set [GLA]₂₆ illustrated in FIG. 5, since the appraiser A uses the property in multiple appraisals (appraisals #12, #25, and #35) and the [GLA]₂₆ data field entry 130 from appraisal #12 (i.e., 3,200 sq. ft.) is different from the [GLA]₂₆ data field entries 130 from appraisals #25 and #35 (i.e., 3,000 sq. ft.). Because a majority of the [GLA]₂₆ data field entries 130 by appraiser A (i.e., 2 out of 3 entries) agree upon 3,000 sq. ft., this may be set as the deemed-correct value for this discrepancy. Accordingly the [GLA]₂₆ data field entry 130 from appraisal #12 is flagged as the erroneous entry in FIG. 5, since this entry (3,200 sq. ft.) is discrepant from the deemed-correct value (3,000 sq. ft.).

If there is a tie in the number of times a value is used by the same appraiser in a set of corresponding data field entries, then various tie-breaking procedures may be used. For example, if there is no self-consensus (i.e., decision block 1710 result=NO), then the process proceeds to decision block 1715, in which it is determined whether there is a peer consensus.

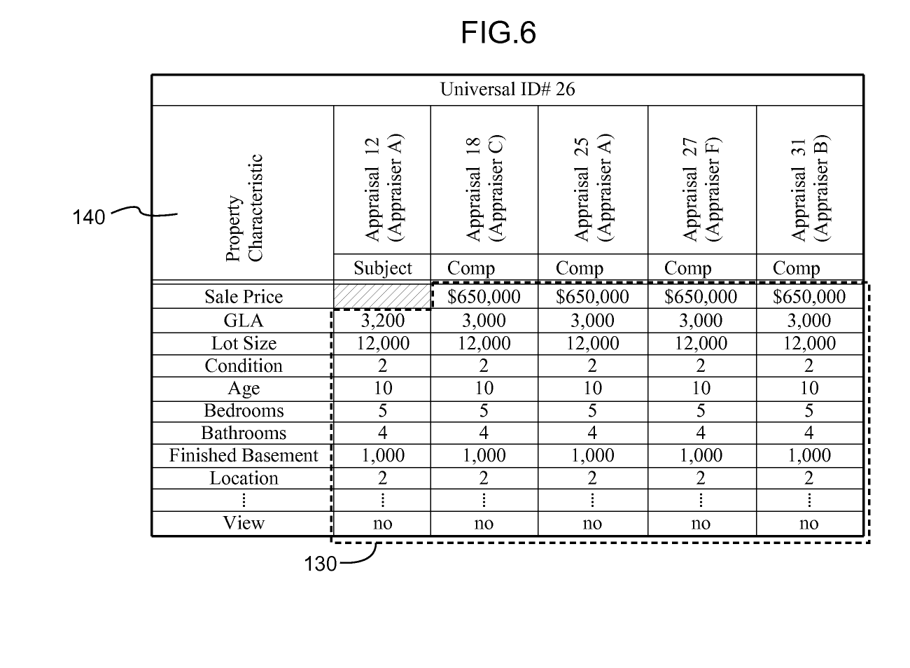

A peer-consensus exists if a value is used by a predetermined proportion of peer data field entries 130 (for simplicity, hereinafter it will be assumed that the predetermined proportion is a simple majority, although this need not be the case). If there is a peer consensus (i.e., decision block 1715 result=YES), then the deemed-correct value for the discrepancy in question may be the peer-consensus value. Thus, in process step 1725 the data field that differs from this deemed-correct value is determined to be the erroneous value. In FIG. 6 there is a self-discrepancy between values in [GLA]₂₆ from appraiser A. Unlike in the case of FIG. 5, in FIG. 6 there is no value used by appraiser A in [GLA]₂₆ more often than another. However, the value 3,000 is agreed upon in [GLA]₂₆ by a majority of peer appraisers, and thus this may be set as the deemed-correct value for this discrepancy. Accordingly the [GLA]₂₆ data field entry 130 from appraisal #12 is flagged as the erroneous entry in FIG. 6, since this entry (3,200 sq. ft.) is discrepant from the deemed-correct value (3,000 sq. ft.).

If there is no peer consensus (i.e., decision block 1715 result=NO), then the value that most decreases (or least increases) the valuation of the subject property in the respective appraisal in which the property data appears is set as the deemed-correct value for the discrepancy. Thus, in process step 1720, the value that differs from the deemed correct value (i.e., the value that most inflates valuation) is determined to be the erroneous value. Generally, when the discrepancy is between data field entries 130 for comps, then the deemed-correct value is the better value of the two (discussed further below). Conversely, when the discrepancy is between data field entries 130 including at least one data field entry 130 from a subject property, then, generally, the deemed-correct value is the worse value of the two. The exception to the forging general rules is when the discrepancy is between Sales Price data field entries 130 for comps, in which case the lower value will always be the deemed-correct value. (subject properties do not have Sales Price data field entries 130, and thus a discrepancy in Sale Price will never include a data field entry 130 from a subject property).

A value is “worse” than another value if it would contribute less to the valuation of a hypothetical property than the other value would, and “better” if it would contribute more. For many property characteristics 140 (including GLA, Lot Size, number of Bathrooms, number of Bedrooms, etc.) the “worse” value is the lower value (and correlatively, the “better” value is the higher value), since having less of these characteristics in a hypothetical property would cause the hypothetical property to be less valuable. Such property characteristics 140 are positively correlated with property value. However, for some property characteristics 140 (such as Age), the higher value is the “worse” value (and correlatively, the “better” value is the lower value). Such property characteristics 140 are negatively correlated with property value. Whether or not certain characteristics are positively or negatively correlated with property value may depend upon the appraisal system being used (for example, if a scaled numerical score is used for “condition”, whether a low numerical value represents the best condition and a high numerical value represents the worst condition, or vice-versa, may be arbitrarily defined by the appraisal system).

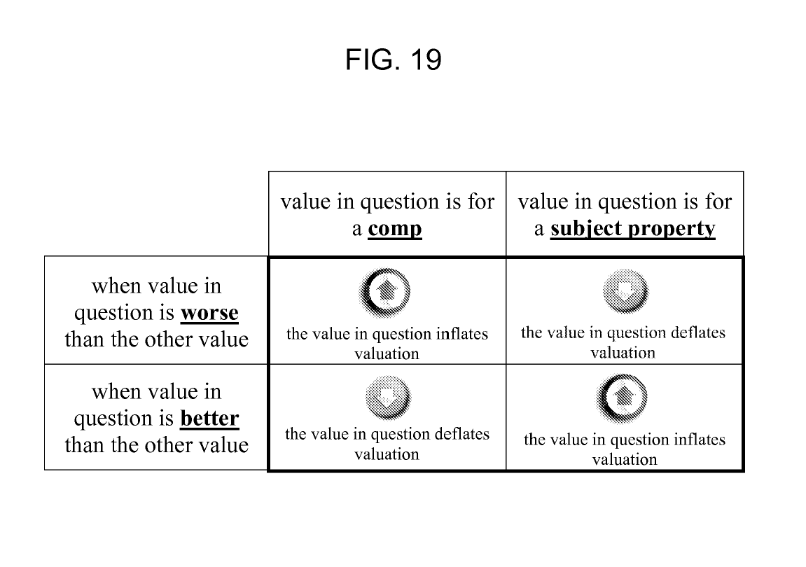

The above-noted general rules for how to determine the value that most decreases (least increases) valuation are explained further as follows. As shown in FIG. 19, when the value in question is for a comp (left two quadrants), then the value in question is going to inflate the valuation if it is the worse value and is going to deflate the valuation if it is the better value. Conversely, when the value in question is for a subject property (right two quadrants), then the value in question is going to deflate the valuation if it is the worse value and is going to inflate the valuation if it is the better value.

Thus, when the discrepancy is between two comps, the worse value will always increase the subject property valuation and the better value will always decrease the subject property valuation. According to the tie breaking rule noted above, the value that most decreases or least increases valuation is the deemed-correct value, and therefore when the discrepancy is between two comps the better value will always be the deemed-correct value (except for the case of sales price, as noted above).

The situation is slightly more complicated when the discrepancy is between a subject property and a comp, since either both values will decrease the valuation or both values will increase the valuation. For example, if the subject property value is the better value, then it will inflate valuation; but if the subject property value is better, then this implies that the comp value is worse, and therefore the comp value would also inflate valuation. Accordingly, since both values will increase of decrease valuation, the one that decreases the valuation the most or increases the valuation the least will be the deemed correct value. The subject property value will always affect the valuation—whether positively or negatively—more than the comp value, because appraisal systems are generally more sensitive to a change in the subject property than to a similar change to one comp. Thus, in the case when both values will decrease the valuation (i.e., when the comp value is better and the subject property value is worse), the value that decreases the valuation the most will be the deemed correct value, which will be the subject property value (i.e., the worse value). Further, in the cause when both values will increase the valuation (i.e., when the comp value is worse and the subject property is better), the value that increases the valuation the least will be the deemed correct value, which will be the comp value (i.e., the worse value). Thus, when the discrepancy involves a subject property data field entry, the worse value is always the deemed-correct value.

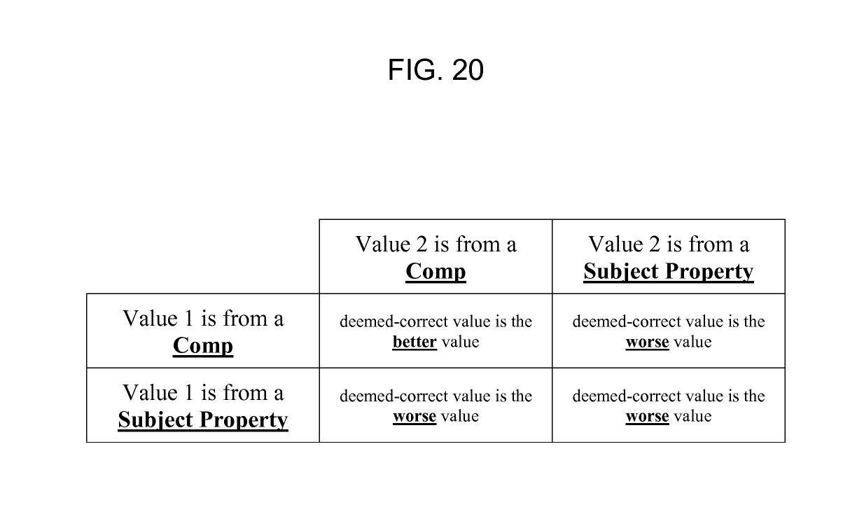

The above-noted results are summarized in FIG. 20. FIG. 21 comprises a table in which the value that is the deemed-correct value is illustrated, based on whether the values 1 and 2 are from comps or from a subject property.

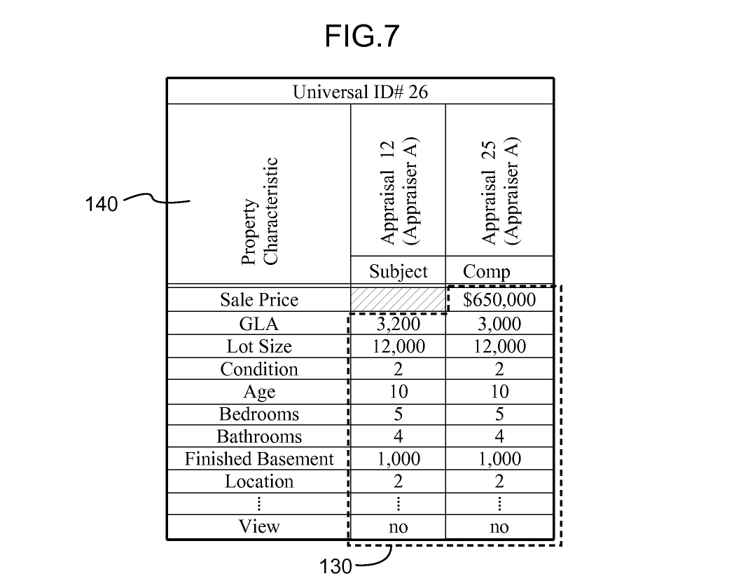

For example, in FIG. 7, there is a self-discrepancy between values in [GLA]₂₆ from appraiser A, and there is no value used by appraiser A in [GLA]₂₆ more often than another and there is no peer-majority value. The discrepancy is between a data field entry 130 for a subject property and a data field entry 130 for a comp, and therefore according to the above-noted general rules as illustrated in FIG. 20, the deemed-correct value is the worse value of the two. Here, the value of 3,000 sq. ft. is the worse value of the two because it is the lower value and GLA is positively correlated with property valuation. Thus, the value of 3,000 sq. ft. will be set as the deemed-correct value, and the data entry field in appraisal #12 will be flagged as an error because it is discrepant from the deemed-correct value. Although not illustrated, if the data field entry 130 in appraisal #12 were for a comp rather than for a subject property, then the opposite result would obtain (i.e., 3,200 sq. ft. would be the deemed-correct value and the data entry field in appraisal #25 would be flagged as an error), because according to the above-noted general rules, the deemed-correct value is the better value of the two when all values are for comps.

Each of process steps 1705, 1725, and 1720 result in the determination of an erroneous data field entry, and after any of these process steps the process proceeds to decision block 1730, in which it is determined whether or not the erroneous data field entry 130 is a typographical error (discussed further below).

If the erroneous data field entry 130 is a typographical error (i.e., decision block 1730 result=YES), then the process proceeds to process step 1745 and the erroneous data entry field is not flagged as an error. Alternatively, the erroneous data field entry 130 may be flagged with a specific typographical error flag that is different from the other error flags discussed further below. Sub-process A ends if process step 1745 is reached.

If the erroneous data field entry 130 is not a typographical error (i.e., decision block 1730 result=NO), then the process proceeds to decision block 1735, in which it is determined whether or not the erroneous data field entry 130 is an outlier-discrepancy (discussed further below).

If the erroneous data field entry 130 is an outlier-discrepancy (i.e., decision block 1735 result=YES), then the process proceeds to process step 1750 in which the erroneous data field entry 130 is flagged as both a self-discrepancy type error and an outlier-discrepancy type error. Sub-process A ends if process step 1750 is reached.

If the erroneous data field entry 130 is not an outlier-discrepancy (i.e., decision block 1735 result=NO), then the process proceeds to process step 1740 in which the erroneous data field entry 130 is flagged as a self-discrepancy type error. Sub-process A ends if process step 1740 is reached.

Peer-Discrepancies:

In the preferred configuration of the process step 1640 illustrated in FIG. 16, if the discrepancy is a peer-discrepancy type, then the process continues to sub-process B as illustrated in FIG. 17B to determine which if any of the discrepant values is an error. As noted above, a peer-discrepancy is a discrepancy between corresponding data field entries 130 entered by different appraisers.

In decision block 1755, it is determined whether or not a peer-consensus exists. A peer-consensus is a value agreed upon by a certain predetermined proportion of peer data field entries 130 (for simplicity, hereinafter it will be assumed that the predetermined proportion is a simple majority, although this need not be the case).

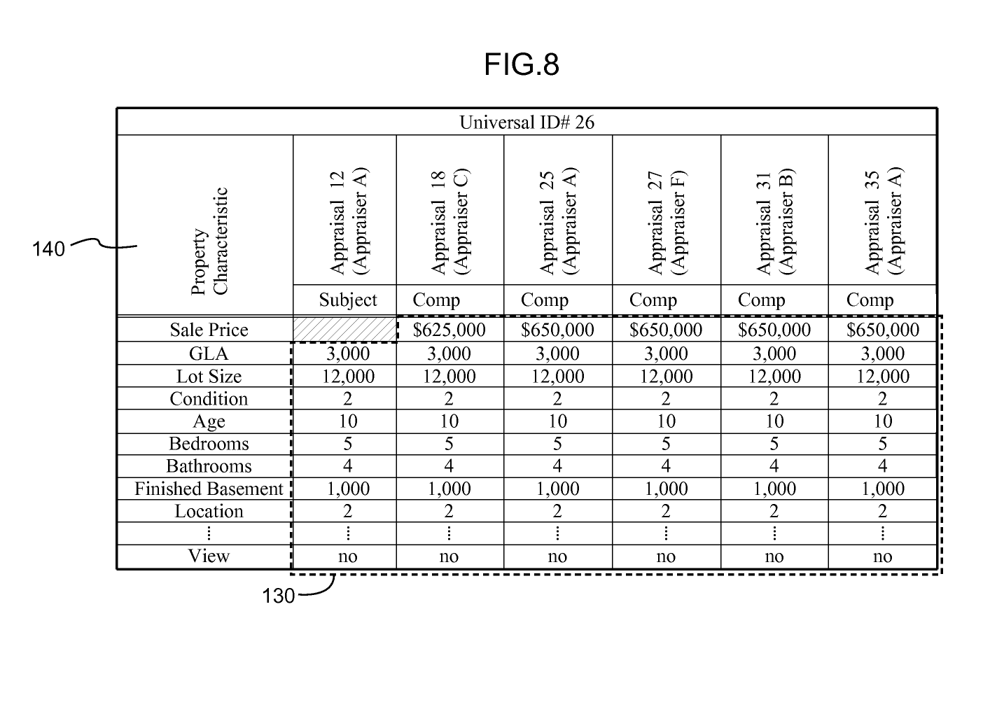

If there is a peer-consensus value (i.e., decision block 1755 result=YES), then the process proceeds to decision block 1760, in which it is determined whether or not at least a predetermined number of different peer appraisers agree on the peer-consensus value (for simplicity, hereinafter it will be assumed that the predetermined number is three, although this need not be the case). If three different peer appraisers agree on the peer-consensus value (i.e., decision block 1760 result=YES), then the peer-consensus value is set as the deemed-correct value. Thus, the process continues to process step 1770, and the data field entry 130 that differs from this deemed-correct value is determined to be the erroneous value. In FIG. 8, there is a peer-discrepancy in [Sale Price]₂₆ between appraisal #18 and the appraisals #25, #27, #31, and #35 (note that a subject property, such as in appraisal #12, does not include a sale price and thus is not considered). In FIG. 8, because there is a value that is agreed upon by (1) a majority of the peer data field entries 130, and (2) at least three different peer appraisers—namely the value $650,000—this value is considered the deemed-correct value. In the event that no peer-consensus value exists, then alternative rules could be applied to determine a deemed-correct value. However, it is preferable that if no peer-consensus value exists, that no deemed-correct value be determined and none of the discrepancies are flagged as errors. One reason for the difference between the criteria for detecting an error in peer-discrepancies and the criteria for detecting an error in self-discrepancies is that self-discrepancies may be more likely indicative of fraud than peer-discrepancies. Another reason for the difference in criteria may be that sometimes there may be a legitimate difference in opinion between peer appraisers as to a property characteristic; self-discrepancies, on the other hand, generally always indicate an error of some sort, since having a legitimate difference of opinion with oneself is unlikely. When a majority of peers including three or more different peers agree upon a value, however, it is considered that the discrepancy is now unlikely to merely be a difference of opinion and is now more likely to indicate an error.

In decision block 1775 it is determined whether or not the erroneous data field entry 130 is a typographical error (discussed further below).

If the erroneous data field entry 130 is a typographical error (i.e., decision block 1775 result=YES), then the process proceeds to process step 1765. Further, the process also proceeds to process step 1765 when the result of either of decisions blocks 1755 or 1760 is NO. In process step 1765 the erroneous data entry field is not flagged as an error. Alternatively, the erroneous data field entry 130 may be flagged with a specific typographical error flag that is different from the other error flags discussed further below. Sub-process B ends if process step 1765 is reached.

If the erroneous data field entry 130 is not a typographical error (i.e., decision block 1775 result=NO), then the process proceeds to decision block 1780, in which it is determined whether or not the erroneous data field entry 130 is an outlier-discrepancy (discussed further below).

If the erroneous data field entry 130 is an outlier-discrepancy (i.e., decision block 1780 result=YES), then the process proceeds to process step 1785 in which the erroneous data field entry 130 is flagged as both a peer-discrepancy type error and an outlier-discrepancy type error. Sub-process B ends if process step 1785 is reached.

If the erroneous data field entry 130 is not an outlier-discrepancy (i.e., decision block 1780 result=NO), then the process proceeds to process step 1790 in which the erroneous data field entry 130 is flagged as a peer-discrepancy type error. Sub-process B ends if process step 1790 is reached.

Outlier-Discrepancies:

An outlier-discrepancy is a self-discrepancy or a peer-discrepancy that additionally meets the following criteria: (1) the discrepancy is of large magnitude, and (2) the erroneous value tends to inflate the appraisal valuation of a subject property. Outlier-discrepancies may also be restricted to only certain property characteristics.

For the first criterion identified above, a predetermined outlier threshold may be set, and when the magnitude of the discrepancy exceeds the outlier threshold the first criterion is satisfied. A different outlier threshold value may be set for each type of property characteristic. Each outlier threshold is larger (generally much larger) than the significance threshold for the same type of property characteristic. For example, for property characteristics 140 such as sales price, GLA, and lot size, the outlier threshold may be set to 15% of the deemed-correct value.

For the second criterion, one may determine whether the erroneous value tends to inflate valuation by considering whether it is better or worse than the deemed-correct value and applying the general rules discussed above with respect to self-discrepancies, which are summarized, in FIG. 19. In this case, it is unnecessary to determine which of the two values inflates/deflates valuation more/less than the other value—as long as the erroneous value inflates valuation to some degree, it satisfies the second criterion.

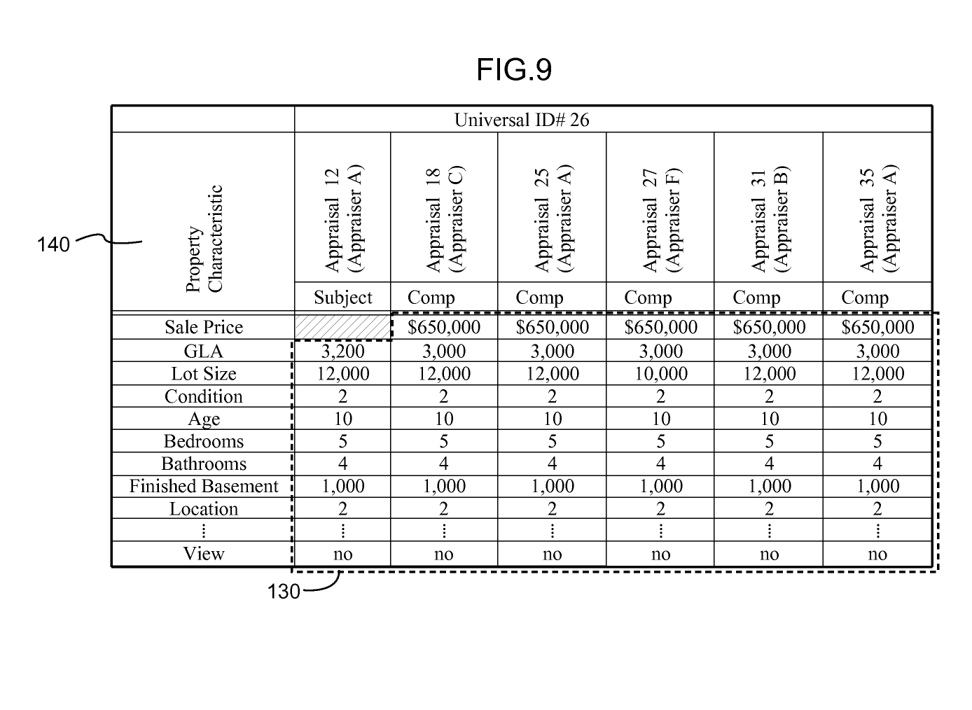

FIG. 9 illustrates an example of an outlier-discrepancy in [Lot Size]₂₆. The data field entry 130 for appraisal #27 in [Lot Size]₂₆ is a peer-discrepancy because it is different from the peer-consensus value of 12,000 sq. ft. Moreover, the magnitude of the discrepancy (i.e., the difference between the erroneous value and the deemed-correct value) is 2,000 sq. ft., which is 16.7% of the deemed-correct value. Assuming an outlier threshold of 15%, the first criterion is met. The erroneous value is for a comp and is “worse” than the deemed-correct value (10,000 sq. ft. would contribute less to the hypothetical valuation of a home than 12,000 sq. ft. would), and thus according to FIG. 19 the erroneous value tends to inflate the price of the subject property of appraisal #27. Both criteria for an outlier-discrepancy being satisfied, the data field entry 130 for appraisal #27 in [Lot Size]₂₆ is determined to be an outlier-discrepancy (as well as a peer-discrepancy).

In determining a type of discrepancy, the appraisal evaluation module may consider values with very small differences as being the same. For example, the appraisal evaluation module may round values before determining whether or not they agree with each other. For example, Sale Price data field entries 130 may be rounded to the nearest $1000, and GLA, Lot Size, and Basement size may be rounded to the nearest 10 sq. ft. The rounding threshold may preferably be less than the above described significance threshold. However, rounding may alternatively be used in lieu of the significance threshold.

Typographical Errors:

When a discrepancy is extremely large then it is likely that the erroneous data field entry 130 is the result of a simple typographical error. For example, such extremely large discrepancies may occur by accidentally adding or dropping a zero when entering a number (e.g., 10,000 instead of 1,000), transposing two numbers (9,100 instead of 1,900), or simply entering the wrong number because of an errant key stroke or because they look confusingly similar in the appraiser's notes (e.g., 7,000 instead of 1,000). These types of errors are very unlikely to be indicative of fraud, since a person intent on misrepresenting a value in an appraisal would be unlikely to misrepresent the number by a very large amount, since very large discrepancies are more likely to stand out and draw suspicion. Instead, a person intent on fraudulently misrepresenting a value generally attempts to keep the fraudulent value somewhat close to the correct value so as to avoid raising red-flags. For example, an appraiser trying to increase the appraised value of the subject property might change a GLA data field entry 130 of one of the comps from 2,500 to 2,000, but the appraiser would be very unlikely to change the data field entry 130 to 250 sq. ft. Similarly, these types of errors are unlikely to be indicative of an appraiser's negligence in ascertaining the property characteristics, since it is highly unlikely that even a negligent appraiser would err by such a large amount. For example, it is possible that an appraiser may incorrectly—although unintentionally—measure the square footage of a property's basement as 950 sq. ft. when it is actually 920 sq. ft., but it is highly unlikely that an appraiser would incorrectly measure it to be 92 sq. ft.

While, these types of errors do indicate a certain amount of negligence on the part of the appraiser—namely, lack of due care in entering values into data fields—fraud and/or negligence in ascertaining property characteristics 140 are generally more likely to go undetected by conventional appraisal review than sloppy data entry. Accordingly, those discrepancies that are extremely large may be identified by the appraisal evaluation module as typographical errors, and may be treated differently than other identified errors. For example, the appraisal evaluation module may refrain from flagging typographical errors as errors, or may flag typographical errors differently than other errors. The appraisal evaluation module may refrain from assigning a discrepancy score (discussed further below) to typographical errors, assign a smaller discrepancy score to typographical errors than to other types of errors, or may assign a normal discrepancy score to typographical errors but include an indication in the error flag that the error is likely a typographical error.

Threshold values for determining typographical errors may be predetermined constant values, may be variable values (such as a percentage of the higher value), or a combination of predetermined constant values and variable values. For example, a discrepancy whose magnitude is greater than a predetermined percentage of the higher of the two discrepant values may be identified as a typographical error. For example, when a discrepancy's magnitude is 75% or more of the higher value, the erroneous value may be identified as a typographical error. Alternatively, a discrepancy may be identified as a typographical error when the value of either of the discrepant data field entries 130 (as opposed to the magnitude of the discrepancy) is below a minimum value or above a maximum value. For example, certain predetermined values for minimum and maximum acceptable data field entry 130 values may be established, such as $1,001 minimum and $9,999,999 maximum for Sale Price. Moreover, any data field entry 130 with values falling outside the min/max range may be identified as typographical errors even when the is no discrepancy detected, such as when there are not yet any other corresponding data field entries 130 that could cause a discrepancy with the given data field entry.

Discrepancy Score:

The appraisal evaluation module determines a discrepancy score to assign to each data field flagged as an error. As mentioned above, the magnitude of the discrepancy score will depend on how much risk the error creates. “Risk” in this context means a risk of over- or under-valuation of the subject property. The more that an error affects an estimated valuation of a subject property, the more risky it is.

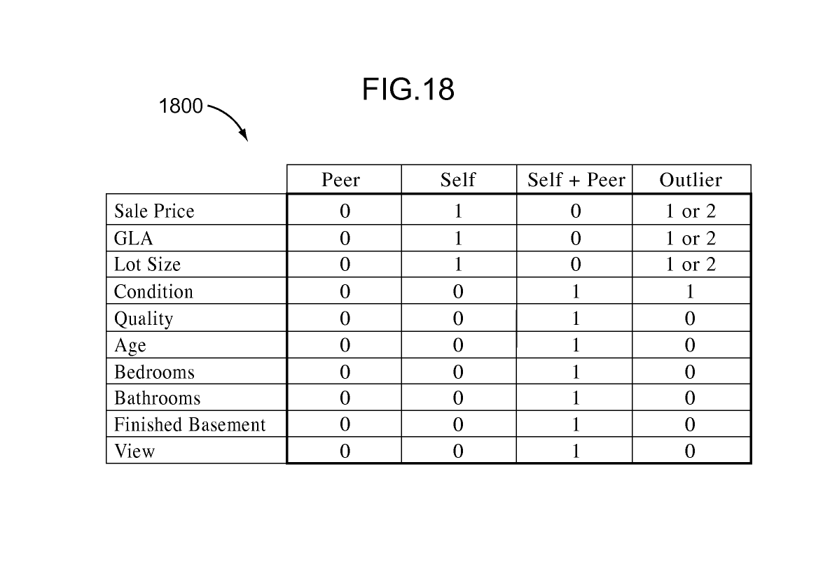

Various ways in which the magnitude of the discrepancy score depend on how much risk the error creates are discussed below. In particular, specific examples of discrepancy scores will be discussed with respect to FIG. 18. It will be understood that the examples discussed are not exhaustive of the ways in which the magnitude of the discrepancy score may depend on how much risk the error creates and the specific allocations of discrepancy scores that are discussed are not limiting.

FIG. 18 shows one illustrative example of discrepancy scores that could be assigned to different types of errors. In the exemplary discrepancy score allocation scheme shown in FIG. 18, each flagged error is assigned one point. Additional “penalty” points may be added to certain types of errors based on an amount of risk associated with the error, and/or based on how likely it is that the error represents fraud

The appraisal evaluation module may determine a type of the discrepancy associated with the error, and assign a discrepancy score based on the type of discrepancy. An error of the self-discrepancy type may be assigned a higher discrepancy score than a peer-discrepancy error, and an error of the outlier-discrepancy type may be assigned a higher discrepancy score than other types of errors.

FIG. 18 illustrates one example of how the appraisal evaluation module may assign a discrepancy score based on the type of discrepancy. For example, in FIG. 18 certain self-discrepancies are assigned an additional penalty point to their discrepancy score (e.g. self-discrepancies in Sales Price, GLA, and Lot Size), whereas otherwise identical peer-discrepancies for those same property characteristics 140 are not assigned an additional point.

The appraisal evaluation module may determine a type of property characteristic 140 associated with the erroneous data field entry, and assign a discrepancy score based on the type of property characteristic 140. Errors for certain types of property characteristics 140 are more risky than errors for other types of property characteristics 140. This is because some types of property characteristics 140 tend to contribute more to the valuation of the subject property than other types of property characteristics 140, and thus an error therein is more likely to result in an under- or over-valuation. Moreover, for the very reason that these types of property characteristics 140 affect the valuation more, an appraiser attempting to fraudulently increase the valuation of the subject property is more likely to misrepresent one of these types of property characteristics 140 than others, and thus errors for these property characteristics 140 are more likely to be indicative of fraud.

FIG. 18 illustrates one example of how the appraisal evaluation module may assign a discrepancy score based on the type of property characteristic 140. In FIG. 18 additional penalty points are available for some types of property characteristics 140 (e.g., GLA, Sales Price, Lot Size, Condition, Quality, Age, Bedrooms, Bathrooms, Finished Basement, Location, and View), whereas other property characteristics 140 can only have the one base point. Furthermore, an additional penalty point for outlier discrepancies may be assigned only for some types of property characteristics 140 (e.g., GLA, Sales Price, Lot Size, and Condition), whereas outliers in other types of property characteristics 140 may not receive additional points (or alternatively might be excluded from being identified as an outlier-discrepancy despite otherwise meeting the criteria for outlier discrepancies). Moreover, some types of property characteristics 140 (e.g., GLA, Sales Price, and Lot Size) may be assigned an additional point when the discrepancy is of the self-discrepancy type, whereas other types of property characteristics 140 (e.g., Condition, Quality, Age, Bedrooms, Bathrooms, Finished Basement, Location, and View) may require the error to be both of the self-discrepancy type and of the peer-discrepancy type before an additional point is assigned.

The appraisal evaluation module may determine a magnitude of the discrepancy (i.e., an absolute value of the difference between the erroneous data field entry 130 and the deemed-correct value), and assign a discrepancy score based on the magnitude. Errors of comparatively higher magnitude are more risky than other errors.

FIG. 18 illustrates one example of how the appraisal evaluation module may assign a discrepancy score based on the magnitude. In FIG. 18, discrepancies that qualify as outlier-discrepancies—which by definition are of comparatively higher magnitude than other discrepancies—may be given additional penalty points. Moreover, some outlier discrepancies may be assigned two additional points instead of one when the discrepancy is of a particularly large magnitude. For example, an aggravated-outlier threshold may be set which is higher than the outlier threshold, and when the discrepancy has a magnitude greater than the aggravated-outlier threshold the outlier may be assigned two additional points rather than the usual one additional point assigned to regular outliers. As one possible example, the aggravated-outlier threshold may be set to 35% of the deemed-correct value.

The appraisal evaluation module may assign a discrepancy score based on whether the erroneous data field entry 130 tends to inflate the valuation of the subject property of the appraisal in which the error occurs. The module may determine whether the erroneous data field entry 130 tends to inflate the valuation of the subject property of the appraisal in which the error occurs, and assign higher discrepancy scores when it does so. Errors that tend to inflate the valuation of the subject property of the appraisal in which the error occurs are more risky than other errors (in this case, risk means risk to those relying on the appraisal such as financial intuitions, rather than risk of over- or under-valuation). Moreover, errors that tend to inflate the valuation of the subject property tend to be more indicative of fraud, since the incentives to misrepresent property characteristics 140 generally push for over-valuation more than for under-valuation.

FIG. 18 illustrates one example of how the appraisal evaluation module may assign a discrepancy score based on whether the erroneous data field entry 130 tends to inflate the valuation of the subject property of the appraisal in which the error occurs. In FIG. 18 additional penalty points are assigned for certain outlier- and self-discrepancies, as discussed above. Recall that to qualify as an outlier-discrepancy (and therefore to receive any additional points resulting from being an outlier) an error must tend to inflate the valuation of the subject property. Moreover, to qualify as self-discrepancy under the tie-breaking criteria discussed above (and therefore to receive any additional points resulting from being a self-discrepancy) an error must tend to most-inflate (or least-decrease) the valuation of the subject property.

The appraisal evaluation module may assign a discrepancy score based on whether the erroneous data field entry 130 is for a subject property. The module may determine whether the erroneous data field entry 130 is for a subject property, and assign a higher discrepancy score when it is. Errors made in data field entries 130 for a subject property affect the valuation of the subject property more than errors in data field entries for comps.

FIG. 18 illustrates one example of how the appraisal evaluation module may assign a discrepancy score based on whether the erroneous data field entry 130 is for a subject property. In FIG. 18, an additional penalty point may be assessed for each error that is in a subject property, in addition to any other discrepancy score points resulting from the errors. Alternatively, only one subject-property penalty may be added to the property discrepancy score (discussed more below) when an error occurs in the subject property, regardless of how many such errors occur.

In addition to the specific examples discussed above, the magnitude of the discrepancy score may be considered to “depend at least in part upon how much the flagged appraisal-data-field being assigned the discrepancy value affects a valuation of a subject property in the property appraisal that includes the flagged appraisal-data-field entry” when the discrepancy score assigned to at least some errors is higher than that assigned to other errors, where at least some of the errors assigned higher discrepancy scores tend to affect an estimated valuation of a subject property more than those errors assigned a lower discrepancy value.

Property Discrepancy Score:

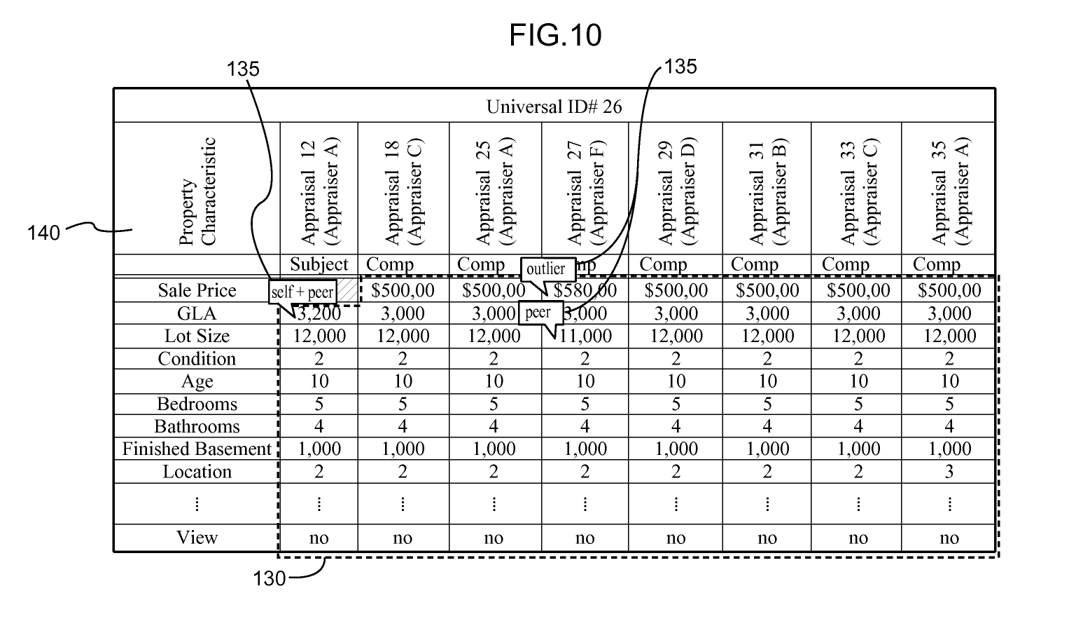

Each instance of property data in an appraisal may be assigned a property discrepancy score 125, which reflects all of the individual discrepancy scores for each data field entry 130 of the property data. The property discrepancy score 125 may simply be the sum of the individual discrepancy scores for each data field entry 130 of the property data, or it may be a scaled score. For example, FIG. 10 illustrates a property identified by UID #26, which includes property data from eight appraisals. In FIG. 10, three flagged errors 135 are illustrated: one in [GLA]₂₆ (appraisal #12), one in [Sale Price]₂₆ (appraisal #27), and one in [Lot Size]₂₆ (appraisal #27).

The flagged error 135 in [GLA]₂₆ of appraisal #12 is both a self-discrepancy and a peer-discrepancy and is for a subject property, and therefore the discrepancy score for this error is three points (one point for being an error, one additional point for being a self-discrepancy in GLA, and one subject-property penalty point). There are no other flagged errors 135 in the data field entries 130 of appraisal #12 with respect to UID 26, and therefore the property discrepancy score for the property data for UID 26 of appraisal #12 is simply the same as the discrepancy score of its only flagged error 135—three points.

No flagged errors 135 occur in the property data for UID 26 of appraisals #18, #25, #29, #31, #33, or #35, and therefore the property discrepancy scores for these instances of property data are all zero points, since the discrepancy score of each of their data field entries 130 is zero points.

The flagged error 135 in [Sale Price]₂₆ of appraisal #27 is an outlier-discrepancy of a peer type, and therefore the discrepancy score for this error is two points (one point for being an error, and one additional point for being a Sale Price Outlier). The flagged error 135 in [Lot Size]₂₆ of appraisal #27 is a peer-discrepancy, and therefore the discrepancy score for this error is one point (one point for being an error, and no additional points).

Thus, the property discrepancy score 125 for the property data for UID 26 of appraisal #27 is the discrepancy score for the first flagged error 135 (two points) plus the discrepancy score for the second flagged error 135 (one point), which equals three points.

Total Discrepancy Score:

Each appraisal is assigned a total discrepancy score 145 by the appraisal evaluation module. The total discrepancy score 145 reflects the cumulative risk posed by all of the flagged errors 135 contained in data field entries 130 of the appraisal. For example, the total discrepancy score 145 may equal a sum of the property discrepancy scores 125 for all of the properties used in the appraisal. The total discrepancy score 145 may also be scaled to make review thereof by appraisal reviewers easier. For example, the total discrepancy score 145 may be on a scale from 1 to 5, with 1 indicating no discrepancies (and hence little risk) and 5 indicating severe discrepancies (and hence great risk).

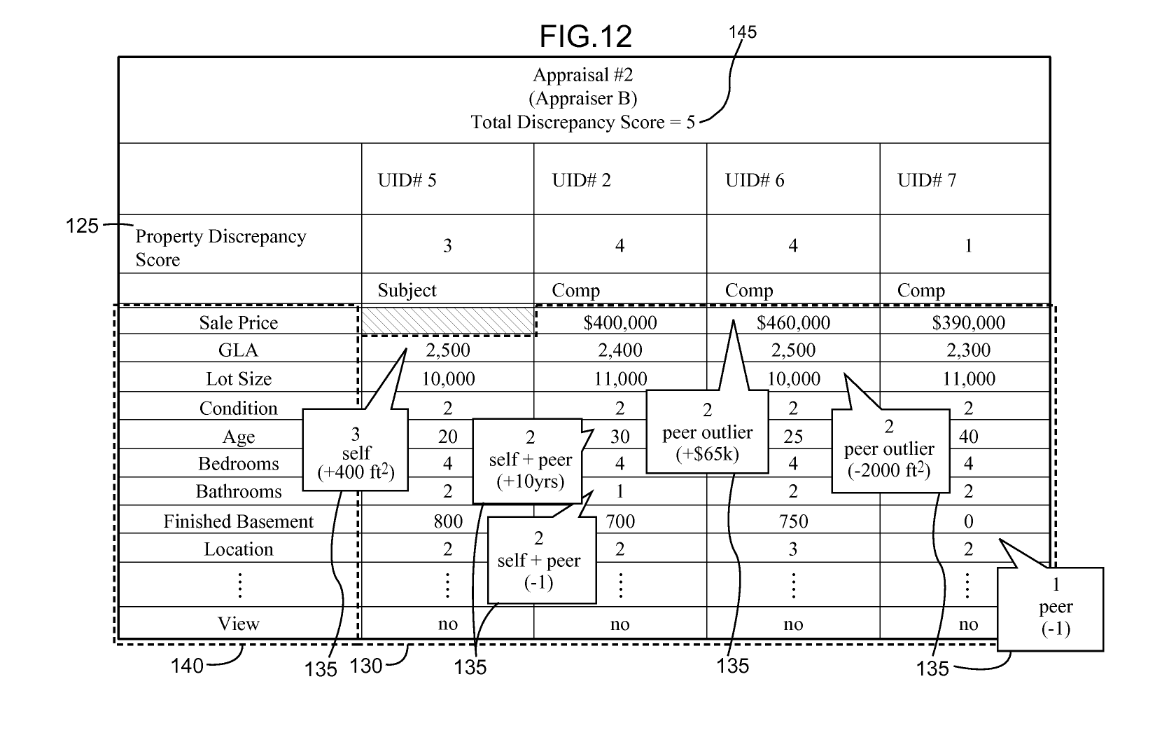

FIG. 12 illustrates an appraisal #2. Appraisal #2 has a total discrepancy score 145 of 5. This is because the sum of the property discrepancy scores 125 for the property data included in the appraisal is relatively high. In particular, the property discrepancy score 125 for UID 5 is three points, the property discrepancy scores 125 for UID 2 and UID 6 are both four points, and the property discrepancy score 125 for UID 7 is one point.

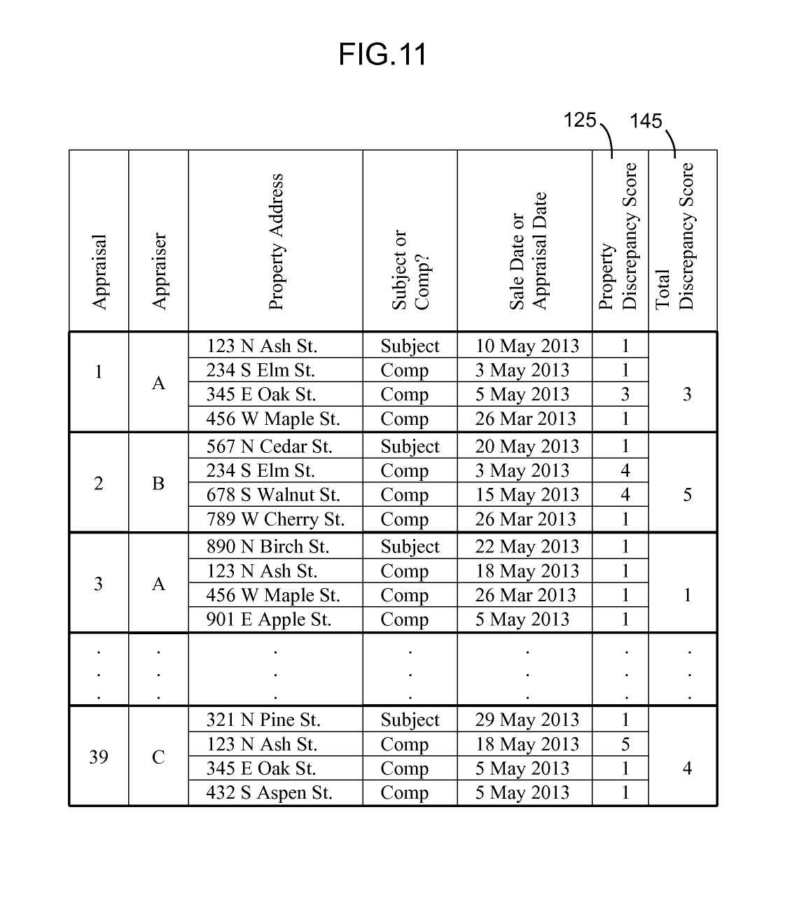

FIG. 11 illustrates appraisal data after the appraisal evaluation module has detected discrepancies. Total discrepancy scores 145 are assigned to each appraisal. Further, the appraisal evaluation module may display the appraisals along with their respective total discrepancy scores 145 in a comparative manner. For example, a table similar to that shown in FIG. 11 may be displayed. This allows an appraisal reviewer to quickly determine which appraisals have the most errors and are most likely to constitute a high risk.

The appraisal evaluation module may also allow an appraisal reviewer to select displayed appraisals, in which case information relating to the specific property data used in the selected appraisal may be displayed.

Upon selecting a specific appraisal, a new display may be generated focused upon the selected appraisal. For example, each instance of property data that is included in the selected appraisal may be displayed along with its associated property discrepancy score 125. Moreover, the data field entries 130 for the instances of property data may be displayed in comparative form, so as to facilitate easy review by the appraisal reviewer. The data field entries 130 that have been flagged as erroneous may be displayed in a distinctive manner so as to set them apart from the other data field entries (in FIG. 12, the flagged errors 135 are displayed distinctively by marking them with flags). Information about the flagged error 135 may also be displayed, such as the discrepancy points awarded for the error, the type of error, and/or the magnitude of the error. For example, the display of the selected appraisal may resemble the table shown in FIG. 12.

The appraisal evaluation module may allow the appraisal reviewer to select one of the instances of property data shown in the display of the selected appraisal. Upon selection of an instance of property data, the appraisal evaluation module may generate a new display in which all instances of property data that have the same UID as the selected instance of property data are displayed. The display of the instances of property data may include displaying the data field entries 130 of the various instances of property data in a comparative manner. The data field entries 130 that have been flagged as erroneous (flagged errors 135) may be displayed in a distinctive manner so as to set them apart from the other data field entries. Information about the flagged errors may also be displayed, such as the discrepancy points awarded for the error, the type of error, and/or the magnitude of the error. For example, the display of the selected appraisal may resemble the table shown in FIG. 10.

Any of the aforementioned displays may also include an indication of the appraiser who made the appraisal, for example as shown in FIGS. 10, 11, and 12. The appraisal evaluation module may allow the appraisal reviewer to select an appraiser from these displays, whereupon information about appraisals performed by the selected appraiser may be displayed (not illustrated). For example, an average total discrepancy score for the appraiser may be displayed, corresponding to an average of total discrepancy scores of appraisals performed by the appraiser. The average may be straight or weighted and may be total or moving—for example, more recent appraisals may be weighted more heavily. Moreover, some or all of the appraisals performed by the appraiser may be displayed, along with their associated total discrepancy score (not illustrated). The displayed appraisals may be ordered by total discrepancy score, date, location of subject property, etc. The appraisal evaluation module may also determine an appraiser score for each appraiser who has submitted appraisal data to the database, and may display the appraiser score of the selected appraiser (not illustrated). The appraiser score may indicate the reliability of the appraiser and/or the likelihood of fraudulent activity. The appraiser score may be based upon the total discrepancy scores of appraisals submitted by the appraiser. The appraiser score may take into account the aforementioned average total discrepancy score, but may be different therefrom. For example, the appraiser score may be scaled. Furthermore, the appraiser score may reflect information not captured by the average total discrepancy score. For example, it may be considered that a single really bad appraisal may be indicative of fraud or serious negligence, even if the appraiser has many other appraisals that are fine. Thus, the appraiser score for a given appraiser may be high if the appraiser has one appraisal with a very large total discrepancy score, such as 5, even if the appraiser has many other appraisals with total discrepancy scores of only 1. On the other hand, the average total discrepancy score in such a case would be somewhat low, since the average is dragged down by the appraisals with scores of 1. Moreover, it may be considered that numerous appraisals with moderate discrepancy scores may be indicative of fraud or serious negligence. Thus, the appraiser score for a given appraiser may be high if the appraiser has numerous appraisals with a moderate total discrepancy score, such as 2 or 3. On the other hand, the average total discrepancy score in such a case would be moderate to low. The appraiser score may also assign more weight to appraisals that are more likely to be indicative of fraud. For example, the appraiser score may give more weight to total discrepancy scores resulting predominantly from self-discrepancies.

In the illustrative example discussed above, various thresholds were described. It will be understood that not all of the thresholds need to be implemented, and that additional threshold may be implemented. If all of the above-noted thresholds are implemented, then preferably they have the following relationship: [rounding threshold]<[significance threshold]<[outlier threshold]<[aggravated-outlier threshold]<[typographical error threshold]. Merely as one illustrative example, the following thresholds may be implemented for Sale Price: rounding threshold=$1000; significance threshold=$4000 or 2%, whichever is greater; outlier threshold=15%; aggravated-outlier threshold=35%; typographical error threshold=75%.

The above-described illustrative example includes an appraisal evaluation module. In some examples, the appraisal evaluation module may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

### Second Illustrative Example

### Computing Device

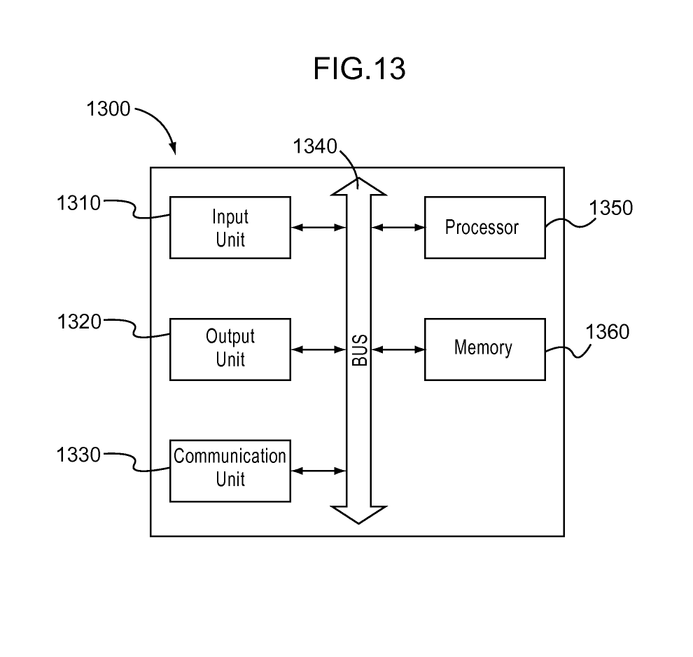

FIG. 13 illustrates an exemplary computing device 1300. The computing device 1300 includes a processor 1350, a memory 1360, a communications unit 1330, an output unit 1320, and an input unit 1310. The components of the computing device 1300 may be connected one to another in various ways, for example via a bus 1340 as shown in FIG. 13. The computing device 1300 may be, for example, a personal computer, laptop computer, tablet device, smartphone, personal digital assistant, server, or the like. The computing device 1300 may include an appraisal evaluation module, which may be stored as program code in the memory 1360 and executed by the processor 1350. Alternatively, the appraisal evaluation module may be stored in a computer program product, such as a compact disc, which is executed by the computing device 1350. The database containing appraisal data may be stored in the memory 1360 of the computing device 1300 with the appraisal evaluation module, or may be stored somewhere else (such as in a remote server or in a removable storage device) and accessed by the appraisal evaluation module via the computing device's 1300 communications unit 1330 (e.g., via a network connection).

### Third Illustrative Example

### System

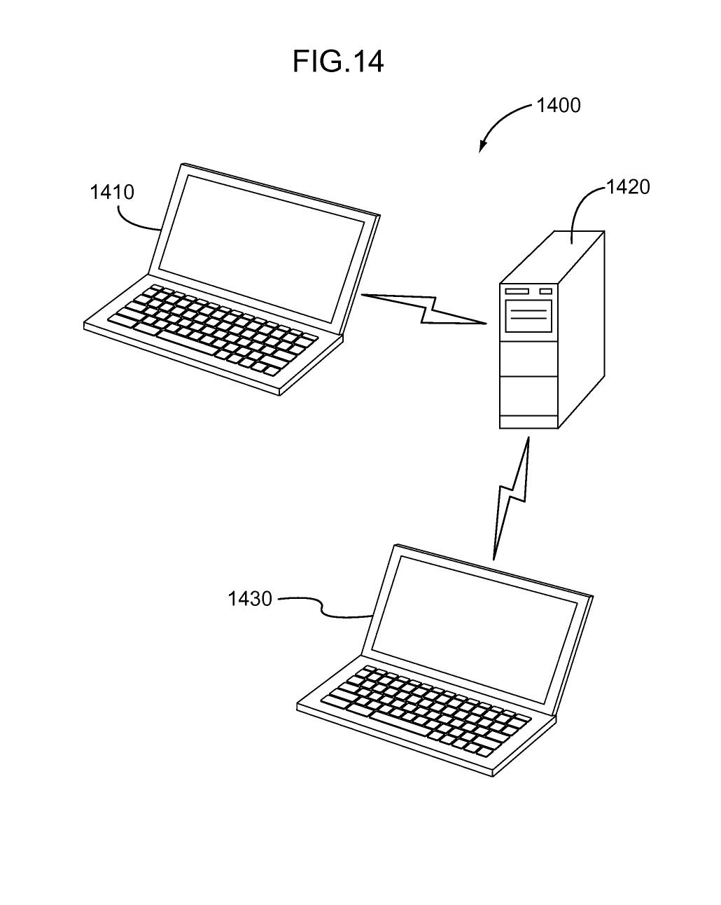

FIG. 14 illustrates an exemplary system 1400 including one or more computing devices 1410/1430 connected to a central computing device 1420, such as a server. The computing devices 1410/1420/1430 may be configured similarly to the above-described computing device 1300 The system 1400 may include an appraisal evaluation module.

The appraisal evaluation module may be stored entirely in a memory one of the computing devices 1410/1420/1430 (for example the central computing device 1420), and may be accessed by the other computing devices 1410/1430 via the network connections. In such a configuration, the computing devices 1410/1430 execute the appraisal evaluation module by accessing the program code stored on the central computing device 1420.

Alternatively, the appraisal evaluation module may be stored in a distributed manner across more than one of the computing devices 1410/1420/1430, and may be accessed by a given one of the computing devices via the network connections. For example, the computing devices 1410/1430 may have stored in their respective memories a user interface portion of the appraisal evaluation module, while the central computing device 1420 stores in a memory thereof a database portion and/or an evaluation process performing portion of the appraisal evaluation module. In such a configuration, a user may execute the user interface portion of the appraisal evaluation module stored on a computing device 1410, causing the computing device 1410 to communicate with the central computing device 1420. In response, the computing device 1420 may execute the portions of the appraisal evaluation module stored therein and communicate data generated thereby to the computing device 1410. The computing device 1410 may then, via the continued execution of the user interface portion of the appraisal evaluation module stored therein, display the data obtained from the central computing device 1420.

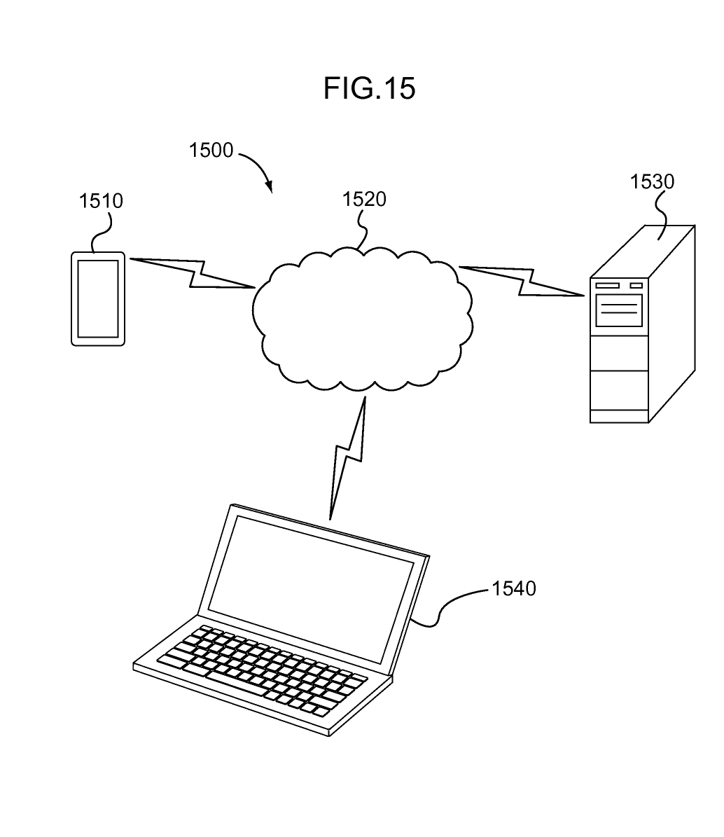

While the example of FIG. 14 illustrates the computing devices 1410/1420/1430 being connected via a private network, such as a LAN, the computing devices 1410/1420/1430 may be connected by other means. For example, as illustrated in FIG. 15, the computing devices 1510/1530/1540 of the system 1500 may be connected to each other via intermediate networks 1520, such as the internet. For example, the central computing device 1530 may host a webpage that includes data generated from an appraisal evaluation module executed by the central computing device 1530, and users of the computing devices 1510/1540 may view the data generated from the appraisal evaluation module by opening the webpage on the computing devices computing devices 1510/1540.

Computing devices such as the computing devices 1300, 1410/1420/1430, and 1510/1530/1540 generally include computer-executable instructions such as the instructions of the appraisal evaluation module, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

It is understood that as used herein and in the appended claims a processor may “perform” a particular function by issuing the appropriate commands to other units (e.g., other components of the computing device, peripheral devices linked to the computing device, other computing devices, etc.), the commands being such as would cause the other units to take certain actions related to the function. For example, although a processor obviously does not display an image in the sense of the processor itself physically emitting light in a pattern, the processor may nonetheless “perform” the function of “displaying” an image in the sense of issuing the appropriate commands that would cause a display device to emit light in the pattern. To continue the example, the display device that the processor causes to display the image may be part of the computing device that includes the processor, or may be connected remotely to the computing device that includes the processor, for example through a network. Thus, for example, a processor included in a server hosting a webpage and may “display” an image by issuing commands via the internet to another computing device, the commands being such as would cause the remote computing device to display the image. Moreover, for the processor to have “performed” the particular function, the generation of a command that would cause another unit to perform the various actions of the function is sufficient—it is irrelevant whether the other unit actually completes the actions or not.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Although the present invention has been described in considerable detail with reference to certain embodiments thereof, the invention may be variously embodied without departing from the spirit or scope of the invention. Therefore, the following claims should not be limited to the description of the embodiments contained herein in any way. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising, causing a processor to:
access appraisal-data-field entries from a plurality of property appraisals, each of the appraisal-data-field entries indicating a value assigned to a property characteristic of a property included in the respective property appraisal;
perform an error detection operation for each of the accessed appraisal-data-field entries as a target entry, the error detection operation comprising detecting a discrepancy between the target entry and an appraisal-data-field entry corresponding to the target entry; and
flag as erroneous appraisal-data-field entries determined by the error detection operation to be erroneous,
wherein appraisal-data-field entries that correspond to one another indicate respective values assigned to a same property characteristic of a same property.

2. The method of claim 1, further comprising causing the processor to:
assign respective numerical discrepancy values to flagged appraisal-data-field entries,
wherein a magnitude of the discrepancy value assigned to at least one of the flagged appraisal-data-field entries is different than a magnitude of the discrepancy value assigned to at least one other of the flagged appraisal-data-field entries.

3. The method of claim 2, further comprising causing the processor to:
assign a total discrepancy score to at least one of the plurality of property appraisals that depends upon a sum of any numerical discrepancy values assigned to those appraisal-data-field entries that are included in the property appraisal being assigned the total discrepancy score.

4. The method of claim 3, further comprising causing the processor to:
display data corresponding to at least some of the plurality of property appraisals, the displayed data including the respective total discrepancy scores assigned thereto,
receive input specifying one of the displayed property appraisals, and
display in response to the received input at least any flagged appraisal-data-field entries of the specified property appraisal in association with respective deemed-correct values for the displayed flagged appraisal-data-field entries.

5. The method of claim 2,
wherein respective magnitudes of the assigned discrepancy values depend at least in part upon how much the flagged appraisal-data-field being assigned the discrepancy value affects valuation of a subject property in the property appraisal that includes the flagged appraisal-data-field entry being assigned the discrepancy value.

6. The method of claim 2,
wherein respective magnitudes of the assigned discrepancy values depend on a type of property characteristic indicated by the flagged appraisal-data-field entry being assigned a discrepancy value.

7. The method of claim 2,
wherein respective magnitudes of the assigned discrepancy values depend on at least one of: a type of property characteristic indicated by the flagged appraisal-data-field entry being assigned the discrepancy value, a discrepancy type of the discrepancy detected for the flagged appraisal-data-field entry being assigned the discrepancy value, and a magnitude of the discrepancy detected for the flagged appraisal-data-field entry being assigned the discrepancy value.

8. The method of claim 7, further comprising causing the processor to:
assign a total discrepancy score to at least one of the plurality of property appraisals that depends upon a sum of any numerical discrepancy values assigned to those appraisal-data-field entries that are included in the property appraisal total discrepancy score.

9. The method of claim 7,
wherein respective magnitudes of the assigned discrepancy values further depend upon how much the flagged appraisal-data-field entry being assigned the discrepancy value affects a valuation of a subject property of the appraisal that includes the flagged appraisal-data-field entry being assigned the discrepancy value.

10. The method of claim 7,
wherein the magnitude of the numerical discrepancy value further depends upon whether the target entry corresponds to a subject property of the respective property appraisal that includes the target entry.

11. The method of claim 2,
wherein respective magnitudes of the assigned discrepancy values depend on a discrepancy type of the discrepancy detected for the flagged appraisal-data-field entry being assigned the discrepancy value, and
said discrepancy types include self-discrepancies and peer-discrepancies.

12. The method of claim 11,
wherein a target entry for which a self-discrepancy is detected is flagged as erroneous when at least one of the following is true:
a value different from the value of the target entry is agreed upon by at least a predetermined number of appraisal-data-field entries that correspond to the target entry, and
the target entry inflates a valuation of a subject property of the appraisal that includes the target entry.

13. The method of claim 11,
wherein a target entry for which a peer-discrepancy is detected is flagged as erroneous when a value different from the value of the target entry is agreed upon by at least a predetermined number of appraisal-data-field entries that correspond to the target entry.

14. The method of claim 11,
wherein the discrepancy types include outlier discrepancies, and a flagged appraisal-data-field entry has an outlier discrepancy when:
a magnitude of the discrepancy detected for the target entry exceeds a predetermined threshold, and
the target entry inflates a valuation of a subject property of the appraisal that includes the target entry.

15. The method of claim 11,
wherein, for at least one type of property characteristic, a higher discrepancy value is assigned when a detected discrepancy is both a self-discrepancy and a peer-discrepancy than when an otherwise identical detected discrepancy is only one of a peer-discrepancy and a self-discrepancy.

16. The method of claim 11,
wherein for at least one type of property characteristic, a higher discrepancy value is assigned when a self-discrepancy is detected than when an otherwise identical peer-discrepancy is detected.

17. A computer program product comprising a non-transitory computer readable medium having program code stored thereon, the program code being executable by a processor to perform the method of claim 1.

18. A method comprising causing a processor to:
access appraisal-data-field entries from a plurality of property appraisals, each of the appraisal-data-field entries indicating a value assigned to a property characteristic in the respective property appraisal;
associate with one another those appraisal-data-field entries that correspond to a same property as one another, correspond to a same property characteristic as one another, and have transaction dates separated by less than a predetermined time from of one another;
perform an error detection operation for each of the accessed appraisal-data-field entries as a target entry, the error detection operation comprising detecting a discrepancy between the target entry and an appraisal-data-field entry associated therewith;
flag as erroneous appraisal-data-field entries determined by the error detection operation to be erroneous, said flag indicating a type and magnitude of the detected discrepancy; and
identify at least one property appraisal of the plurality of property appraisals as suspect based upon flagged appraisal-data-field entries.

19. A computing device comprising:
at least one processor, and
a memory unit, having stored thereon program code executable by the at least one processor to perform the method of claim 1.

20. A system comprising:
at least one processor;
a database including a plurality of appraisal-data-field entries from a plurality of property appraisals, each of the appraisal-data-field entries indicating a value assigned to a property characteristic in the respective property appraisal; and
a non-transitory computer readable medium having program code stored thereon, the program code being executable by the at least one processor to perform the following operations:
access the appraisal-data-field entries from the database,
perform an error detection operation for each of the accessed appraisal-data-field entries as a target entry, the error detection operation comprising detecting a discrepancy between the target entry and an appraisal-data-field entry corresponding to the target entry,
flag as erroneous appraisal-data-field entries determined by the error detection operation to be erroneous, said flag indicating a type and magnitude of the discrepancy, and
identify at least one property appraisal of the plurality of property appraisals as suspect based upon flagged appraisal-data-field entries,
wherein appraisal-data-field entries that correspond to one another indicate respective values assigned to a same property characteristic of a same property.
